(19) United States
(12) Patent Application Publication
(10) Pub. No.: US 2026/0073643 A1
(43) Pub. Date: Mar. 12, 2026

(54) RENDERING-BASED IPD ADAPTATION

(71) Applicant: Snap Inc., Santa Monica, CA (US)

(72) Inventors: Jan Bajana, Vienna (AT); Clemens Birklbauer, Vienna (AT); Georg Halmetschlager-Funek, Vienna (AT); Michael Hecher, Wien (AT); Jeroen Diederik Hol, Hengelo (NL); Matthias Kalkgruber, Vienna (AT); Simon Schreiberhuber, Vienna (AT)

(21) Appl. No.: 18/883,960

(22) Filed: Sep. 12, 2024

(51) Int. Cl. G06T 19/00; G06F 3/01; G06T 15/10; G06V 20/20

(52) U.S. Cl. CPC G06T 19/006; G06F 3/013; G06T 15/10; G06V 20/20; G06T 2200/24

(57) ABSTRACT

An XR system is provided that calibrates display parameters. The XR system captures pose data of the XR system relative to a real-world environment using a pose tracking component. Video data of the real-world environment is captured using one or more cameras of the XR system. One or more reference features in the real-world environment are identified using the video data and pose data. The XR system causes display of one or more virtual objects aligned with the reference features using display parameters. A user interface is displayed to allow a user to adjust the display parameters and XR system receives adjustments to the display parameters from the user via the interface and updates the parameters accordingly. An updated pose of the XR system is captured using the pose tracking component and the virtual objects are then re-displayed using the updated display parameters and updated pose.

### TECHNICAL FIELD

The present disclosure relates generally to user interfaces and, more particularly, to user interfaces used for extended reality.

### BACKGROUND

A head-wearable apparatus can be implemented with a transparent or semi-transparent display through which a user of the head-wearable apparatus can view the surrounding environment. Such head-wearable apparatuses enable a user to see through the transparent or semi-transparent display to view the surrounding environment, and to also see objects (e.g., objects such as a rendering of a 2D or 3D graphic model, images, video, text, and so forth) that are generated for display to appear as a part of, and/or overlaid upon, the surrounding environment. This is typically referred to as “augmented reality” or “AR.” A head-wearable apparatus can additionally completely occlude a user's visual field and display a virtual environment through which a user can move or be moved. This is typically referred to as “virtual reality” or “VR.” In a hybrid form, a view of the surrounding environment is captured using cameras, and then that view is displayed along with augmentation to the user on displays the occlude the user's eyes. As used herein, the term extended Reality (XR) refers to augmented reality, virtual reality and any of hybrids of these technologies unless the context indicates otherwise.

A user of the head-wearable apparatus can access and use a computer software application to perform various tasks or engage in an activity. To use the computer software application, the user interacts with a user interface provided by the head-wearable apparatus.

### BRIEF DESCRIPTION OF THE SEVERAL VIEWS OF THE DRAWINGS

In the drawings, which are not necessarily drawn to scale, like numerals can describe similar components in different views. To easily identify the discussion of any particular element or act, the most significant digit or digits in a reference number refer to the figure number in which that element is first introduced. Some non-limiting examples are illustrated in the figures of the accompanying drawings in which:

FIG. 1A is a perspective view of a head-wearable apparatus, according to some examples.

FIG. 1B illustrates a further view of the head-wearable apparatus of FIG. 1A, according to some examples.

FIG. 2 illustrates a system in which the head-wearable apparatus is operably connected to a mobile device, according to some examples.

FIG. 3 illustrates a networked environment, according to some examples.

FIG. 4 is a block diagram showing a software architecture, according to some examples.

FIG. 5 is a diagrammatic representation of a machine in the form of a computer system, according to some examples.

FIG. 6A is a collaboration diagram of components of an XR system, in accordance with some examples.

FIG. 6B is a process flow diagram of a display parameter calibration method, according to some examples.

FIG. 7A and FIG. 7B illustrate a calibration user interface, according to some examples.

FIG. 8A illustrates a machine-learning pipeline, according to some examples.

FIG. 8B illustrates training and use of a machine-learning program, according to some examples.

### DETAILED DESCRIPTION

Extended Reality (XR) systems have emerged as powerful tools for enhancing human perception and interaction with the world. These systems, which encompass augmented reality (AR), virtual reality (VR), and hybrid technologies, enable users to experience digital content seamlessly integrated with their physical environment or to immerse themselves in fully virtual worlds. XR systems have found applications across various domains, including education, healthcare, entertainment, manufacturing, and design. They allow users to visualize complex data, simulate real-world scenarios, collaborate remotely, and interact with digital information in intuitive and natural ways.

XR systems face various problems when delivering immersive and accurate experiences. Aligning virtual content precisely with the real-world environment is challenging due to variations in users'physical characteristics and device fit. Factors like Inter-Pupillary Distance (IPD), vertical offset, and left-right asymmetry can significantly impact how virtual objects appear relative to real-world reference features. Misalignment can lead to visual discomfort, reduced depth perception, and a breakdown of the illusion of virtual objects existing in the physical space. In addition, maintaining consistent and accurate alignment of virtual content as users move and change their viewpoint is complex. The XR system must continuously track the user's position and orientation while adjusting the rendering of virtual objects in real-time. This becomes particularly challenging when combining user movement with the need to account for individual display parameter adjustments.

These problems can result in poor user experiences, reduced effectiveness of XR applications, and potential physical discomfort for users during extended use. Addressing these challenges successfully allows for the creation of compelling and comfortable XR experiences across a wide range of users and use cases.

IPD is a distance between the centers of a user's eye pupils, which is a parameter useful for properly aligning XR displays. Accurate IPD measurement and adjustment in AR systems are used for several reasons. Proper IPD alignment ensures optimal sharpness and clarity of virtual objects for the user. Correct IPD settings help maintain accurate 3D depth perception of virtual objects in the AR environment. Misaligned IPD can lead to eye strain and discomfort during prolonged use.

When there's a mismatch between the user's IPD and the XR device's inter-display distance (IDD), the system can apply pixel offsets to compensate for the difference. This calibration can improve 3D depth estimation, especially at longer distances.

Proper IPD adjustment in XR systems has several impacts on the user experience. Calibration based on individual IPD can reduce depth underestimation at longer distances. Correct IPD alignment ensures proper positioning of virtual objects relative to the user's eyes and maintains optimal focus and clarity. Accurate IPD adjustment allows multiple users to share the same XR device comfortably and enables quick switching between user profiles in various settings.

In some examples, an XR system in accordance with the methodologies described in the this disclosure implements a user-driven calibration process that allows for real-time adjustment of display parameters, including IPD. This process involves rendering virtual content aligned with real-world reference features, allowing the user to adjust display parameters while observing the alignment from multiple viewpoints, and iterating this process until satisfactory alignment is achieved.

In some examples, the XR system captures, using a pose tracking component, pose data of the XR system relative to a real-world environment and captures, using one or more cameras, video data of the real-world environment. The XR system identifies one or more reference features in the real-world environment using the video data and the pose data and causes a display of one or more virtual objects aligned with the one or more reference features using one or more display parameters. In addition, the XR system causes display of a user interface to a user for adjusting the one or more display parameters. The XR system receives, from the user using the user interface, one or more adjustments to the one or more display parameters and updates the one or more display parameters using the one or more adjustments. The XR system captures, using the pose tracking component, an updated pose of the XR system and causes re-display of the one or more virtual objects using the updated one or more display parameters and the updated pose.

In some examples, the one or more display parameters comprise an IPD adjustment display parameter.

Other technical features can be readily apparent to one skilled in the art from the following figures, descriptions, and claims.

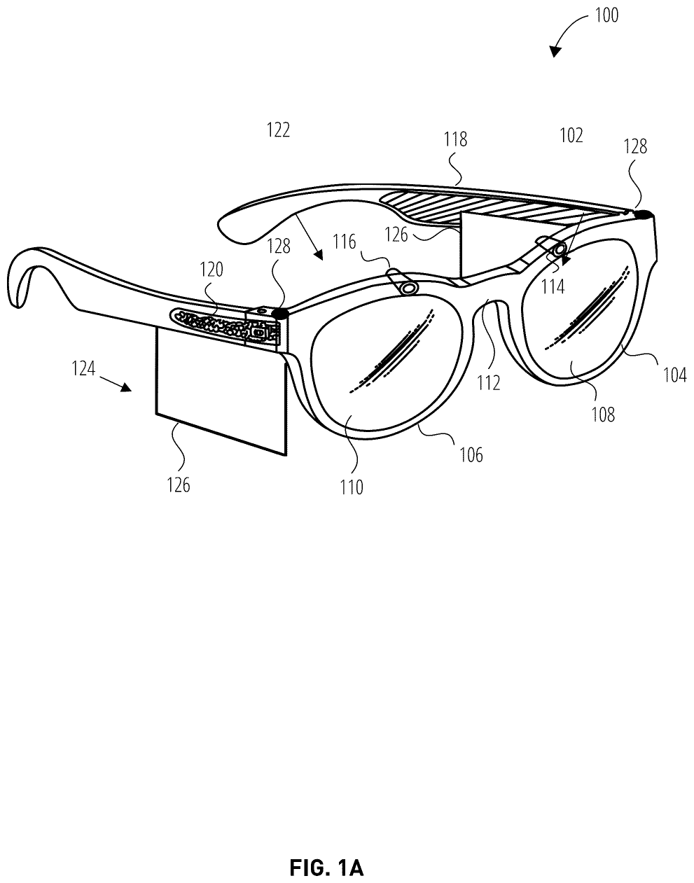

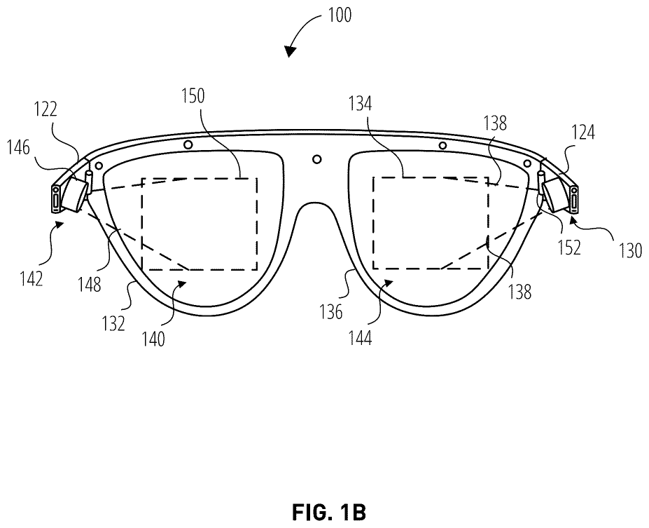

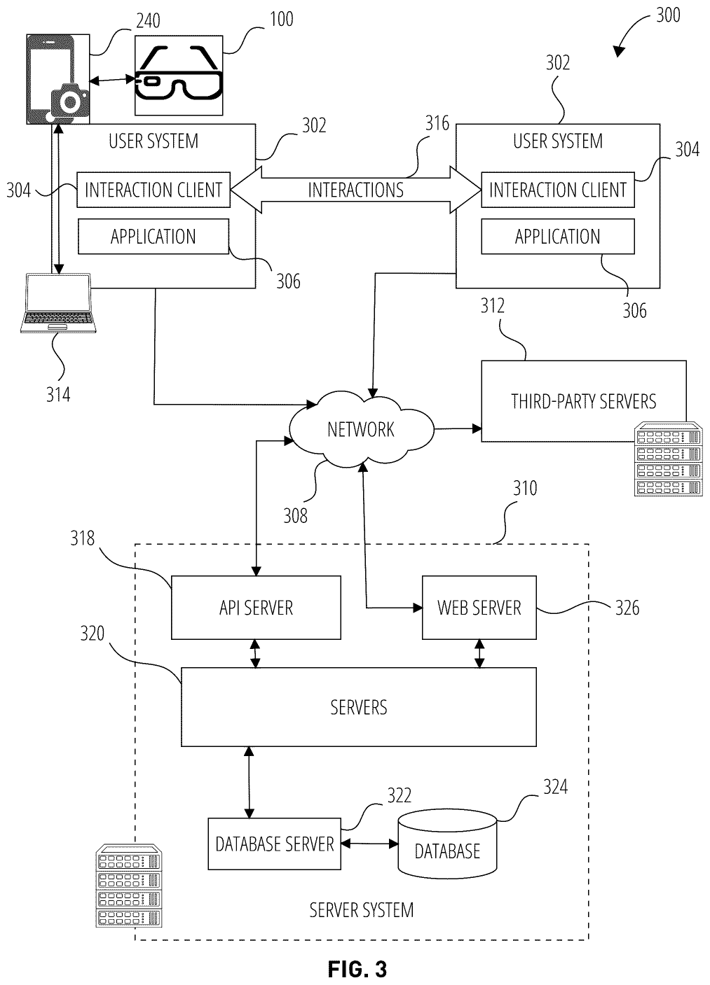

FIG. 1A is a perspective view of a head-wearable apparatus 100 according to some examples. The head-wearable apparatus 100 can be a client device of an XR system, such as a user system 302 of FIG. 3. The head-wearable apparatus 100 can include a frame 102 made from any suitable material such as plastic or metal, including any suitable shape memory alloy. In one or more examples, the frame 102 includes a first or left optical element holder 104 (e.g., a display or lens holder) and a second or right optical element holder 106 connected by a bridge 112. A first or left optical element 108 and a second or right optical element 110 can be provided within respective left optical element holder 104 and right optical element holder 106. The right optical element 110 and the left optical element 108 can be a lens, a display, a display assembly, or a combination of the foregoing. Any suitable display assembly can be provided in the head-wearable apparatus 100.

The frame 102 additionally includes a left arm or left temple piece 122 and a right arm or right temple piece 124. In some examples the frame 102 can be formed from a single piece of material so as to have a unitary or integral construction.

The head-wearable apparatus 100 can include a computing device, such as a computer 120, which can be of any suitable type so as to be carried by the frame 102 and, in one or more examples, of a suitable size and shape, so as to be partially disposed in one of the left temple piece 122 or the right temple piece 124. The computer 120 can include one or more processors with memory, wireless communication circuitry, and a power source. As discussed below, the computer 120 comprises low-power circuitry 224, high-speed circuitry 226, and a display processor. Various other examples can include these elements in different configurations or integrated together in different ways. Additional details of aspects of the computer 120 can be implemented as illustrated by the machine 500 discussed herein.

The computer 120 additionally includes a battery 118 or other suitable portable power supply. In some examples, the battery 118 is disposed in left temple piece 122 and is electrically coupled to the computer 120 disposed in the right temple piece 124. The head-wearable apparatus 100 can include a connector or port (not shown) suitable for charging the battery 118, a wireless receiver, transmitter or transceiver (not shown), or a combination of such devices.

The head-wearable apparatus 100 includes a first or left camera 114 and a second or right camera 116. Although two cameras are depicted, other examples contemplate the use of a single or additional (i.e., more than two) cameras.

In some examples, the head-wearable apparatus 100 includes any number of input sensors or other input/output devices in addition to the left camera 114 and the right camera 116. Such sensors or input/output devices can additionally include biometric sensors, location sensors, motion sensors, and so forth.

In some examples, the left camera 114 and the right camera 116 provide tracking image data for use by the head-wearable apparatus 100 to extract 3D information from a real-world environment.

The head-wearable apparatus 100 can also include a touchpad 126 mounted to or integrated with one or both of the left temple piece 122 and right temple piece 124. The touchpad 126 is generally vertically-arranged, approximately parallel to a user's temple in some examples. As used herein, generally vertically aligned means that the touchpad is more vertical than horizontal, although potentially more vertical than that. Additional user input can be provided by one or more buttons 128, which in the illustrated examples are provided on the outer upper edges of the left optical element holder 104 and right optical element holder 106. The one or more touchpads 126 and buttons 128 provide a means whereby the head-wearable apparatus 100 can receive input from a user of the head-wearable apparatus 100.

FIG. 1B illustrates the head-wearable apparatus 100 from the perspective of a user while wearing the head-wearable apparatus 100. For clarity, a number of the elements shown in FIG. 1A have been omitted. As described in FIG. 1A, the head-wearable apparatus 100 shown in FIG. 1B includes left optical element 140 and right optical element 144 secured within the left optical element holder 132 and the right optical element holder 136 respectively.

The head-wearable apparatus 100 includes right forward optical assembly 130 comprising a left near eye display 150, a right near eye display 134, and a left forward optical assembly 142 including a left projector 146 and a right projector 152.

In some examples, the near eye displays are waveguides. The waveguides include reflective or diffractive structures (e.g., gratings and/or optical elements such as mirrors, lenses, or prisms). Light 138 emitted by the right projector 152 encounters the diffractive structures of the waveguide of the right near eye display 134, which directs the light towards the right eye of a user to provide an image on or in the right optical element 144 that overlays the view of the real-world environment seen by the user. Similarly, light 148 emitted by the left projector 146 encounters the diffractive structures of the waveguide of the left near eye display 150, which directs the light towards the left eye of a user to provide an image on or in the left optical element 140 that overlays the view of the real-world environment seen by the user. The combination of a Graphical Processing Unit, an image display driver, the right forward optical assembly 130, the left forward optical assembly 142, left optical element 140, and the right optical element 144 provide a display engine of the head-wearable apparatus 100. The head-wearable apparatus 100 uses the display engine to generate an overlay of the real-world environment view of the user including display of a user interface to the user of the head-wearable apparatus 100.

It will be appreciated however that other display technologies or configurations can be utilized within a display engine to display an image to a user in the user's field of view. For example, instead of a projector and a waveguide, an LCD, LED or other display panel or surface can be provided.

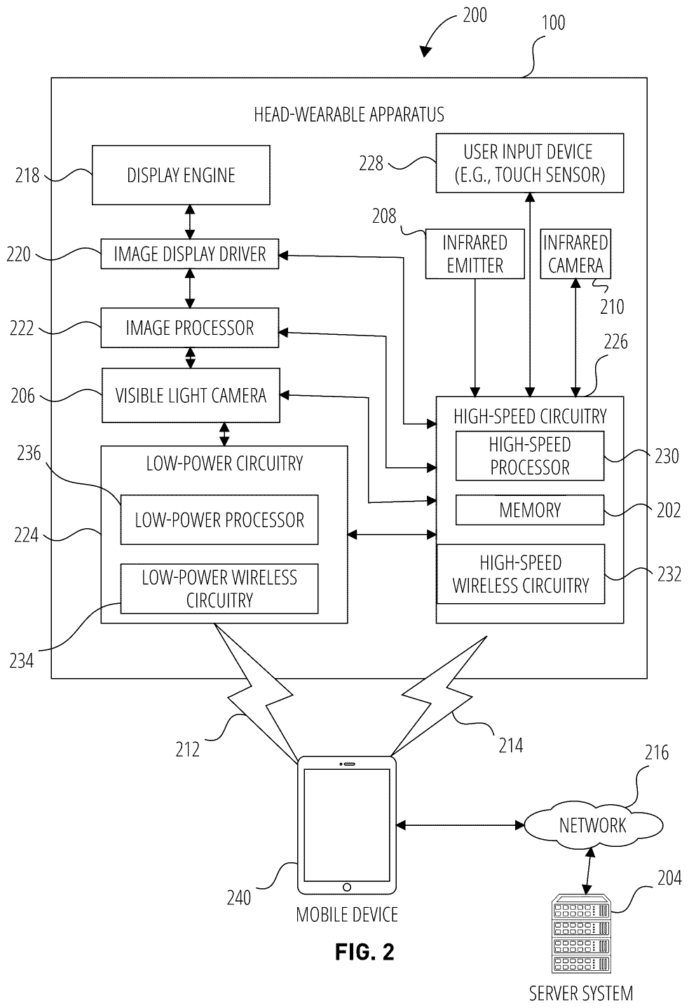

In use, a user of the head-wearable apparatus 100 will be presented with information, content and various user interfaces on the near eye displays. As described in more detail herein, the user can then interact with the head-wearable apparatus 100 using a touchpad 126 and/or the button 128, voice inputs or touch inputs on an associated device (e.g. mobile device 240 illustrated in FIG. 2), and/or hand movements, locations, and positions recognized by the head-wearable apparatus 100.

In some examples, a display engine of an XR system is incorporated into a lens that is in contact with a user's eye, such as a contact lens or the like. The XR system generates images of an XR experience using the contact lens.

In some examples, the head-wearable apparatus 100 comprises an XR system. In some examples, the head-wearable apparatus 100 is a component of an XR system including additional computational components. In some examples, the head-wearable apparatus 100 is a component in an XR system comprising additional user input systems or devices.

FIG. 2 illustrates a system 200 including a head-wearable apparatus 100 with a selector input device, according to some examples. FIG. 2 is a high-level functional block diagram of an example head-wearable apparatus 100 communicatively coupled to a mobile device 240 and various server systems 204 via various.

The head-wearable apparatus 100 includes one or more cameras, each of which can be, for example, a visible light camera 206, an infrared emitter 208, and an infrared camera 210.

The mobile device 240 connects with head-wearable apparatus 100 using both a low-power wireless connection 212 and a high-speed wireless connection 214. The mobile device 240 is also connected to the server system 204 and the networks 216.

The head-wearable apparatus 100 further includes one or more image displays of the display engine 218. The display engines 218 include one associated with the left lateral side and one associated with the right lateral side of the head-wearable apparatus 100. The head-wearable apparatus 100 also includes an image display driver 220, an image processor 222, low-power circuitry 224, and high-speed circuitry 226. The display engine 218 is for presenting images and videos, including an image that can include a graphical user interface to a user of the head-wearable apparatus 100.

The image display driver 220 commands and controls the display engine 218. The image display driver 220 can deliver image data directly to the display engine 218 for presentation or can convert the image data into a signal or data format suitable for delivery to the image display device. For example, the image data can be video data formatted according to compression formats, such as H.264 (MPEG-4 Part 10), HEVC, Theora, Dirac, RealVideo RV40, VP8, VP9, or the like, and still image data can be formatted according to compression formats such as Portable Network Group (PNG), Joint Photographic Experts Group (JPEG), Tagged Image File Format (TIFF) or exchangeable image file format (EXIF) or the like.

The head-wearable apparatus 100 includes a frame and stems (or temples) extending from a lateral side of the frame. The head-wearable apparatus 100 further includes a user input device 228 (e.g., touch sensor or push button), including an input surface on the head-wearable apparatus 100. The user input device 228 (e.g., touch sensor or push button) is to receive from the user an input selection to manipulate the graphical user interface of the presented image.

The components shown in FIG. 2 for the head-wearable apparatus 100 are located on one or more circuit boards, for example a PCB or flexible PCB, in the rims or temples. Alternatively, or additionally, the depicted components can be located in the chunks, frames, hinges, or bridge of the head-wearable apparatus 100. Left and right visible light cameras 206 can include digital camera elements such as a complementary metal oxide-semiconductor (CMOS) image sensor, charge-coupled device, camera lenses, or any other respective visible or light-capturing elements that can be used to capture data, including images of scenes with unknown objects.

The head-wearable apparatus 100 includes a memory 202, which stores instructions to perform a subset, or all the functions described herein. The memory 202 can also include storage device.

As shown in FIG. 2, the high-speed circuitry 226 includes a high-speed processor 230, a memory 202, and high-speed wireless circuitry 232. In some examples, the image display driver 220 is coupled to the high-speed circuitry 226 and operated by the high-speed processor 230 to drive the left and right image displays of the display engine 218. The high-speed processor 230 can be any processor capable of managing high-speed communications and operation of any general computing system needed for the head-wearable apparatus 100. The high-speed processor 230 includes processing resources needed for managing high-speed data transfers on a high-speed wireless connection 214 to a wireless local area network (WLAN) using the high-speed wireless circuitry 232. In certain examples, the high-speed processor 230 executes an operating system such as a LINUX operating system or other such operating system of the head-wearable apparatus 100, and the operating system is stored in the memory 202 for execution. In addition to any other responsibilities, the high-speed processor 230 executing a software architecture for the head-wearable apparatus 100 is used to manage data transfers with high-speed wireless circuitry 232. In certain examples, the high-speed wireless circuitry 232 is configured to implement Institute of Electrical and Electronic Engineers (IEEE) 802.11 communication standards, also referred to herein as WI-FI®. In some examples, other high-speed communications standards can be implemented by the high-speed wireless circuitry 232.

The low-power wireless circuitry 234 and the high-speed wireless circuitry 232 of the head-wearable apparatus 100 can include short-range transceivers (e.g., Bluetooth™, Bluetooth LE, Zigbee, ANT+) and wireless wide, local, or wide area Network transceivers (e.g., cellular or WI-FI®). Mobile device 240, including the transceivers communicating via the low-power wireless connection 212 and the high-speed wireless connection 214, can be implemented using details of the architecture of the head-wearable apparatus 100, as can other elements of the network 216.

The memory 202 includes any storage device capable of storing various data and applications, including, among other things, camera data generated by the left and right visible light cameras 206, the infrared camera 210, and the image processor 222, as well as images generated for display by the image display driver 220 on the image displays of the display engine 218. While the memory 202 is shown as integrated with high-speed circuitry 226, in some examples, the memory 202 can be an independent standalone element of the head-wearable apparatus 100. In certain such examples, electrical routing lines can provide a connection through a chip that includes the high-speed processor 230 from the image processor 222 or the low-power processor 236 to the memory 202. In some examples, the high-speed processor 230 can manage addressing of the memory 202 such that the low-power processor 236 will boot the high-speed processor 230 any time that a read or write operation involving memory 202 is needed.

As shown in FIG. 2, the low-power processor 236 or high-speed processor 230 of the head-wearable apparatus 100 can be coupled to the camera (visible light camera 206, infrared emitter 208, or infrared camera 210), the image display driver 220, the user input device 228 (e.g., touch sensor or push button), and the memory 202.

The head-wearable apparatus 100 is connected to a host computer. For example, the head-wearable apparatus 100 is paired with the mobile device 240 via the high-speed wireless connection 214 or connected to the server system 204 via the network 216. The server system 204 can be one or more computing devices as part of a service or network computing system, for example, that includes a processor, a memory, and network communication interface to communicate over the network 216 with the mobile device 240 and the head-wearable apparatus 100.

The mobile device 240 includes a processor and a Network communication interface coupled to the processor. The Network communication interface allows for communication over the network 216, low-power wireless connection 212, or high-speed wireless connection 214. The mobile device 240 can further store at least portions of the instructions in the memory of the mobile device 240 memory to implement the functionality described herein.

Output components of the mobile device 240 include visual components, such as a display such as a liquid crystal display (LCD), a plasma display panel (PDP), a light-emitting diode (LED) display, a projector, or a waveguide. The image displays of the optical assembly are driven by the image display driver 220. The output components of the mobile device 240 further include acoustic components (e.g., speakers), haptic components (e.g., a vibratory motor), other signal generators, and so forth. The input components of the mobile device 240, the mobile device 240, and server system 204, such as the user input device 228, can include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or other pointing instruments), tactile input components (e.g., a physical button, a touch screen that provides location and force of touches or touch gestures, or other tactile input components), audio input components (e.g., a microphone), and the like.

The head-wearable apparatus 100 can also include additional peripheral device elements. Such peripheral device elements can include sensors and display elements integrated with the head-wearable apparatus 100. For example, peripheral device elements can include any I/O components including output components, motion components, position components, or any other such components described herein.

In some examples, the head-wearable apparatus 100 can include biometric components or sensors to detect expressions (e.g., hand expressions, facial expressions, vocal expressions, body gestures, or eye-tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The biometric components can include a brain-machine interface (BMI) system that allows communication between the brain and an external device or machine. This can be achieved by recording brain activity data, translating this data into a format that can be understood by a computer, and then using the resulting signals to control the device or machine.

Example types of BMI technologies, including:
Electroencephalography (EEG) based BMIs, which record electrical activity in the brain using electrodes placed on the scalp.
Invasive BMIs, which used electrodes that are surgically implanted into the brain.
Optogenetics BMIs, which use light to control the activity of specific nerve cells in the brain.

Any biometric data collected by the biometric components is captured and stored with only user approval and deleted on user request, and in accordance with applicable laws.

Further, such biometric data can be used for very limited purposes, such as identification verification. To ensure limited and authorized use of biometric information and other personally identifiable information (PII), access to this data is restricted to authorized personnel only, if at all. Any use of biometric data can strictly be limited to identification verification purposes, and the biometric data is not shared or sold to any third party without the explicit consent of the user. In addition, appropriate technical and organizational measures are implemented to ensure the security and confidentiality of this sensitive information.

The motion components can include acceleration sensor components (e.g., accelerometer), gravitation sensor components, rotation sensor components (e.g., gyroscope), and so forth. The position components can include location sensor components to generate location coordinates (e.g., a Global Positioning System (GPS) receiver component), Wi-Fi or Bluetooth™M transceivers to generate positioning system coordinates, altitude sensor components (e.g., altimeters or barometers that detect air pressure from which altitude can be derived), orientation sensor components (e.g., magnetometers), and the like. Such positioning system coordinates can also be received over low-power wireless connections 212 and high-speed wireless connection 214 from the mobile device 240 via the low-power wireless circuitry 234 or high-speed wireless circuitry 232.

FIG. 3 is a block diagram showing an example digital interaction system 300 for facilitating interactions and engagements (e.g., exchanging text messages, conducting text audio and video calls, or playing games) over a network. The digital interaction system 300 includes multiple user systems 302, each of which hosts multiple applications, including an interaction client 304 and other applications 306. Each interaction client 304 is communicatively coupled, via one or more networks including a network 308 (e.g., the Internet), to other instances of the interaction client 304 (e.g., hosted on respective other user systems), a server system 310 and third-party servers 312). An interaction client 304 can also communicate with locally hosted applications 306 using Applications Program Interfaces (APIs).

Each user system 302 can include multiple user devices, such as a mobile device 240, head-wearable apparatus 100, and a computer client device 314 that are communicatively connected to exchange data and messages.

An interaction client 304 interacts with other interaction clients 304 and with the server system 310 via the network 308. The data exchanged between the interaction clients 304 (e.g., interactions 316) and between the interaction clients 304 and the server system 310 includes functions (e.g., commands to invoke functions) and payload data (e.g., text, audio, video, or other multimedia data).

The server system 310 provides server-side functionality via the network 308 to the interaction clients 304. While certain functions of the digital interaction system 300 are described herein as being performed by either an interaction client 304 or by the server system 310, the location of certain functionality either within the interaction client 304 or the server system 310 can be a design choice. For example, it can be technically preferable to initially deploy particular technology and functionality within the server system 310 but to later migrate this technology and functionality to the interaction client 304 where a user system 302 has sufficient processing capacity.

The server system 310 supports various services and operations that are provided to the interaction clients 304. Such operations include transmitting data to, receiving data from, and processing data generated by the interaction clients 304. This data can include message content, client device information, geolocation information, digital effects (e.g., media augmentation and overlays), message content persistence conditions, entity relationship information, and live event information. Data exchanges within the digital interaction system 300 are invoked and controlled through functions available via user interfaces (UIs) of the interaction clients 304.

Turning now specifically to the server system 310, an Application Program Interface (API) server 318 is coupled to and provides programmatic interfaces to servers 320, making the functions of the servers 320 accessible to interaction clients 304, other applications 306 and third-party server 312. The servers 320 are communicatively coupled to a database server 322, facilitating access to a database 324 that stores data associated with interactions processed by the servers 320. Similarly, a web server 326 is coupled to the servers 320 and provides web-based interfaces to the servers 320. To this end, the web server 326 processes incoming network requests over the Hypertext Transfer Protocol (HTTP) and several other related protocols.

The Application Program Interface (API) server 318 receives and transmits interaction data (e.g., commands and message payloads) between the servers 320 and the user systems 302 (and, for example, interaction clients 304 and other application 306) and the third-party server 312. Specifically, the Application Program Interface (API) server 318 provides a set of interfaces (e.g., routines and protocols) that can be called or queried by the interaction client 304 and other applications 306 to invoke functionality of the servers 320. The Application Program Interface (API) server 318 exposes various functions supported by the servers 320, including account registration; login functionality; the sending of interaction data, via the servers 320, from a particular interaction client 304 to another interaction client 304; the communication of media files (e.g., images or video) from an interaction client 304 to the servers 320; the settings of a collection of media data (e.g., a narrative); the retrieval of a list of friends of a user of a user system 302; the retrieval of messages and content; the addition and deletion of entities (e.g., friends) to an entity relationship graph; the location of friends within an entity relationship graph; and opening an application event (e.g., relating to the interaction client 304).

The interaction client 304 provides a user interface that allows users to access features and functions of an external resource, such as a linked application 306, an applet, or a microservice. This external resource can be provided by a third party or by the creator of the interaction client 304.

The external resource can be a full-scale application installed on the user's system 302, or a smaller, lightweight version of the application, such as an applet or a microservice, hosted either on the user's system or remotely, such as on third-party servers 312 or in the cloud. These smaller versions, which include a subset of the full application's features, can be implemented using a markup-language document and can also incorporate a scripting language and a style sheet.

When a user selects an option to launch or access the external resource, the interaction client 304 determines whether the resource is web-based or a locally installed application. Locally installed applications can be launched independently of the interaction client 304, while applets and microservices can be launched or accessed via the interaction client 304.

If the external resource is a locally installed application, the interaction client 304 instructs the user's system to launch the resource by executing locally stored code. If the resource is web-based, the interaction client 304 communicates with third-party servers to obtain a markup-language document corresponding to the selected resource, which it then processes to present the resource within its user interface.

The interaction client 304 can also notify users of activity in one or more external resources. For instance, it can provide notifications relating to the use of an external resource by one or more members of a user group. Users can be invited to join an active external resource or to launch a recently used but currently inactive resource.

The interaction client 304 can present a list of available external resources to a user, allowing them to launch or access a given resource. This list can be presented in a context-sensitive menu, with icons representing different applications, applets, or microservices varying based on how the menu is launched by the user.

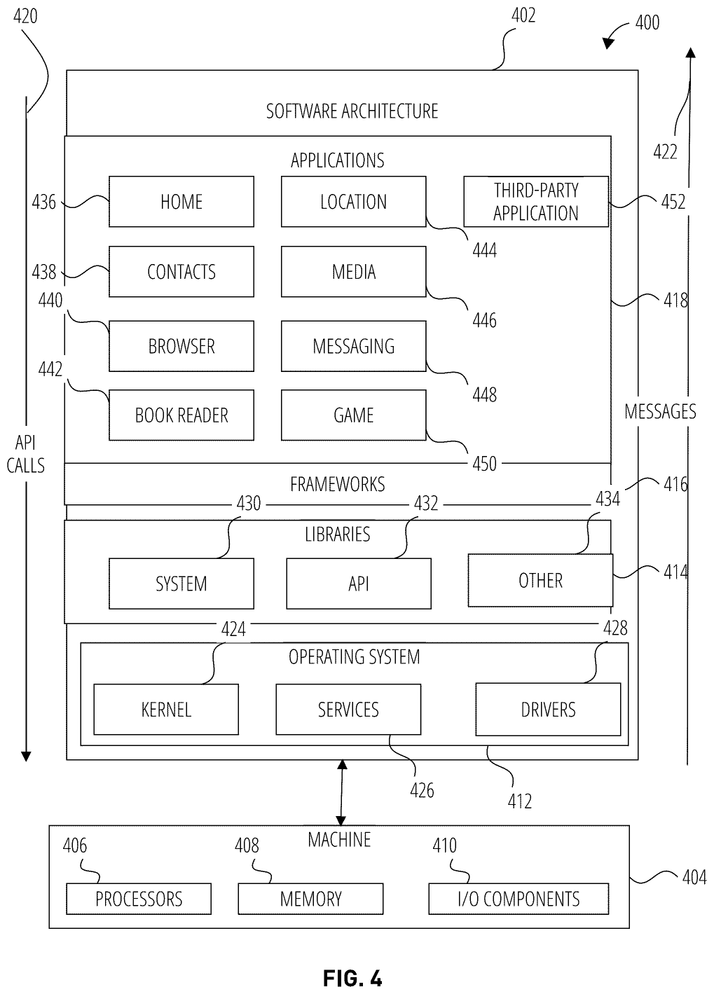

FIG. 4 is a block diagram 400 illustrating a software architecture 402, which can be installed on any one or more of the devices described herein. The software architecture 402 is supported by hardware such as a machine 404 that includes processors 406, memory 408, and I/O components 410. In this example, the software architecture 402 can be conceptualized as a stack of layers, where each layer provides a particular functionality. The software architecture 402 includes layers such as an operating system 412, libraries 414, frameworks 416, and applications 418. Operationally, the applications 418 invoke API calls 420 through the software stack and receive messages 422 in response to the API calls 420.

The operating system 412 manages hardware resources and provides common services. The operating system 412 includes, for example, a kernel 424, services 426, and drivers 428. The kernel 424 acts as an abstraction layer between the hardware and the other software layers. For example, the kernel 424 provides memory management, processor management (e.g., scheduling), component management, networking, and security settings, among other functionalities. The services 426 can provide other common services for the other software layers. The drivers 428 are responsible for controlling or interfacing with the underlying hardware. For instance, the drivers 428 can include display drivers, camera drivers, BLUETOOTH® or BLUETOOTH® Low Energy drivers, flash memory drivers, serial communication drivers (e.g., USB drivers), WI-FI® drivers, audio drivers, power management drivers, and so forth.

The libraries 414 provide a common low-level infrastructure used by the applications 418. The libraries 414 can include system libraries 430 (e.g., C standard library) that provide functions such as memory allocation functions, string manipulation functions, mathematical functions, and the like. In addition, the libraries 414 can include API libraries 432 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 414 can also include a wide variety of other libraries 434 to provide many other APIs to the applications 418.

The frameworks 416 provide a common high-level infrastructure that is used by the applications 418. For example, the frameworks 416 provide various graphical user interface (GUI) functions, high-level resource management, and high-level location services. The frameworks 416 can provide a broad spectrum of other APIs that can be used by the applications 418, some of which can be specific to a particular operating system or platform.

In an example, the applications 418 can include a home application 436, a contacts application 438, a browser application 440, a book reader application 442, a location application 444, a media application 446, a messaging application 448, a game application 450, and a broad assortment of other applications such as a third-party application 452. The applications 418 are programs that execute functions defined in the programs. Various programming languages can be employed to create one or more of the applications 418, structured in a variety of manners, such as object-oriented programming languages (e.g., Objective-C, Java, or C++) or procedural programming languages (e.g., C or assembly language). In a specific example, the third-party application 452 (e.g., an application developed using the ANDROID™ or IOS™ software development kit (SDK) by an entity other than the vendor of a platform) can be mobile software running on a mobile operating system such as IOS™, ANDROID™, WINDOWS® Phone, or another mobile operating system. In this example, the third-party application 452 can invoke the API calls 420 provided by the operating system 412 to facilitate functionalities described herein.

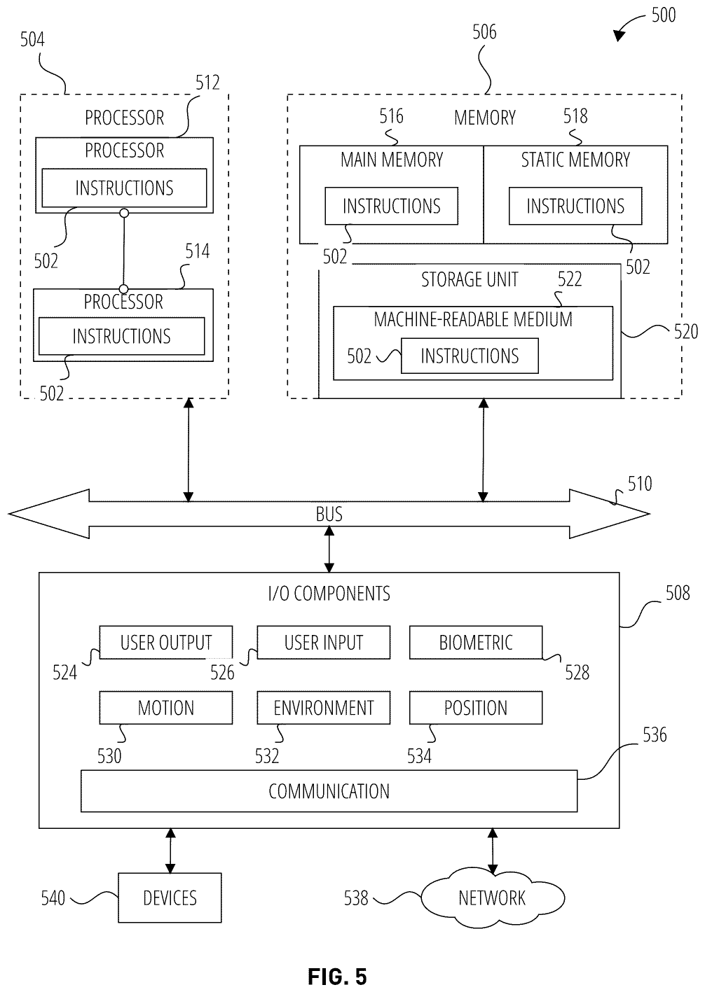

FIG. 5 is a diagrammatic representation of the machine 500 within which instructions 502 (e.g., software, a program, an application, an applet, an app, or other executable code) for causing the machine 500 to perform any one or more of the methodologies discussed herein can be executed. For example, the instructions 502 can cause the machine 500 to execute any one or more of the methods described herein. The instructions 502 transform the general, non-programmed machine 500 into a particular machine 500 programmed to carry out the described and illustrated functions in the manner described. The machine 500 can operate as a standalone device or can be coupled (e.g., networked) to other machines. In a networked deployment, the machine 500 can operate in the capacity of a server machine or a client machine in a server-client network environment, or as a peer machine in a peer-to-peer (or distributed) network environment. The machine 500 can comprise, but not be limited to, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 502, sequentially or otherwise, that specify actions to be taken by the machine 500. Further, while a single machine 500 is illustrated, the term “machine” shall also be taken to include a collection of machines that individually or jointly execute the instructions 502 to perform any one or more of the methodologies discussed herein. The machine 500, for example, can comprise the user system 302 or any one of multiple server devices forming part of the server system 310. In some examples, the machine 500 can also comprise both client and server systems, with certain operations of a particular method or algorithm being performed on the server-side and with certain operations of the method or algorithm being performed on the client-side.

The machine 500 can include one or more hardware processors 504, memory 506, and input/output I/O components 508, which can be configured to communicate with each other via a bus 510.

The processor 504 can comprise one or more processors such as, but not limited to, processor 512 and processor 514. The one or more processors can comprise one or more types of processing systems such as, but not limited to, Central Processing Units (CPUs), Graphics Processing Units (GPUs), Digital Signal Processors (DSPs), Neural Processing Units (NPUs) or AI Accelerators, Physics Processing Units (PPUs), Field-Programmable Gate Arrays (FPGAs), Multi-core Processors, Symmetric Multiprocessing (SMP) Systems, and the like.

The memory 506 includes a main memory 516, a static memory 518, and a storage unit 520, both accessible to the processor 504 via the bus 510. The main memory 506, the static memory 518, and storage unit 520 store the instructions 502 embodying any one or more of the methodologies or functions described herein. The instructions 502 can also reside, completely or partially, within the main memory 516, within the static memory 518, within machine-readable medium 522 within the storage unit 520, within at least one of the processor 504 (e.g., within the processor's cache memory), or any suitable combination thereof, during execution thereof by the machine 500.

The I/O components 508 can include a wide variety of components to receive input, provide output, produce output, transmit information, exchange information, capture measurements, and so on. The specific I/O components 508 that are included in a particular machine will depend on the type of machine. For example, portable machines such as mobile phones can include a touch input device or other such input mechanisms, while a headless server machine will likely not include such a touch input device. It will be appreciated that the I/O components 508 can include many other components that are not shown in FIG. 5. In various examples, the I/O components 508 can include user output components 524 and user input components 526. The user output components 524 can include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The user input components 526 can include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and force of touches or touch gestures, or other tactile input components), audio input components (e.g., a microphone), and the like.

In further examples, the I/O components 508 can include biometric components 528, motion component 530, environmental components 532, or position component 534, among a wide array of other components. For example, the biometric components 528 include components to detect expressions (e.g., hand expressions, facial expressions, vocal expressions, body gestures, or eye-tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The biometric components can include a brain-machine interface (BMI) system that allows communication between the brain and an external device or machine. This can be achieved by recording brain activity data, translating this data into a format that can be understood by a computer, and then using the resulting signals to control the device or machine.

Example types of BMI technologies, including:
Electroencephalography (EEG) based BMIs, which record electrical activity in the brain using electrodes placed on the scalp.
Invasive BMIs, which used electrodes that are surgically implanted into the brain.
Optogenetics BMIs, which use light to control the activity of specific nerve cells in the brain.

Any biometric data collected by the biometric components is captured and stored only with user approval and deleted on user request, and in accordance with applicable laws. Further, such biometric data can be used for very limited purposes, such as identification verification. To ensure limited and authorized use of biometric information and other Personally Identifiable Information (PII), access to this data is restricted to authorized personnel only, if at all. Any use of biometric data can strictly be limited to identification verification purposes, and the data is not shared or sold to any third party without the explicit consent of the user. In addition, appropriate technical and organizational measures are implemented to ensure the security and confidentiality of this sensitive information.

The motion component 530 can include acceleration sensor components (e.g., accelerometer), gravitation sensor components, rotation sensor components (e.g., gyroscope).

The environmental components 532 include, for example, one or cameras (with still image/photograph and video capabilities), illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that can provide indications, measurements, or signals corresponding to a surrounding physical environment.

With respect to cameras, the user system 302 can have a camera system comprising, for example, front cameras on a front surface of the user system 302 and rear cameras on a rear surface of the user system 302. The front cameras can, for example, be used to capture still images and video of a user of the user system 302 (e.g., “selfies”), which can then be modified with digital effect data (e.g., filters) described above. The rear cameras can, for example, be used to capture still images and videos in a more traditional camera mode, with these images similarly being modified with digital effect data. In addition to front and rear cameras, the user system 302 can also include a 360° camera for capturing 360° photographs and videos.

Moreover, the camera system of the user system 302 can be equipped with advanced multi-camera configurations. This can include dual rear cameras, which might consist of a primary camera for general photography and a depth-sensing camera for capturing detailed depth information in a scene. This depth information can be used for various purposes, such as creating a bokeh effect in portrait mode, where the subject is in sharp focus while the background is blurred. In addition to dual camera setups, the user system 302 can also feature triple, quad, or even penta camera configurations on both the front and rear sides of the user system 302. These multiple cameras systems can include a wide camera, an ultra-wide camera, a telephoto camera, a macro camera, and a depth sensor, for example.

Communication can be implemented using a wide variety of technologies. The I/O components 508 further include communication components 536 operable to couple the machine 500 to a Network 538 or devices 540 via respective coupling or connections. For example, the communication components 536 can include a network interface component or another suitable device to interface with the Network 538. In further examples, the communication components 536 can include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 540 can be another machine or any of a wide variety of peripheral devices (e.g., a peripheral device coupled via a USB).

Moreover, the communication components 536 can detect identifiers or include components operable to detect identifiers. For example, the communication components 536 can include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph™, MaxiCode, PDF417, Ultra Code, UCC RSS-2D bar code, and other optical codes), or acoustic detection components (e.g., microphones to identify tagged audio signals). In addition, a variety of information can be derived via the communication components 536, such as location via Internet Protocol (IP) geolocation, location via Wi-Fi® signal triangulation, location via detecting an NFC beacon signal that can indicate a particular location, and so forth.

The various memories (e.g., main memory 516, static memory 518, and memory of the processor 504) and storage unit 520 can store one or more sets of instructions and data structures (e.g., software) embodying or used by any one or more of the methodologies or functions described herein. These instructions (e.g., the instructions 502), when executed by processor 504, cause various operations to implement the disclosed examples.

The instructions 502 can be transmitted or received over the Network 538, using a transmission medium, via a network interface device (e.g., a network interface component included in the communication components 536) and using any one of several well-known transfer protocols (e.g., hypertext transfer protocol (HTTP)). Similarly, the instructions 502 can be transmitted or received using a transmission medium via a coupling (e.g., a peer-to-peer coupling) to the devices 540.

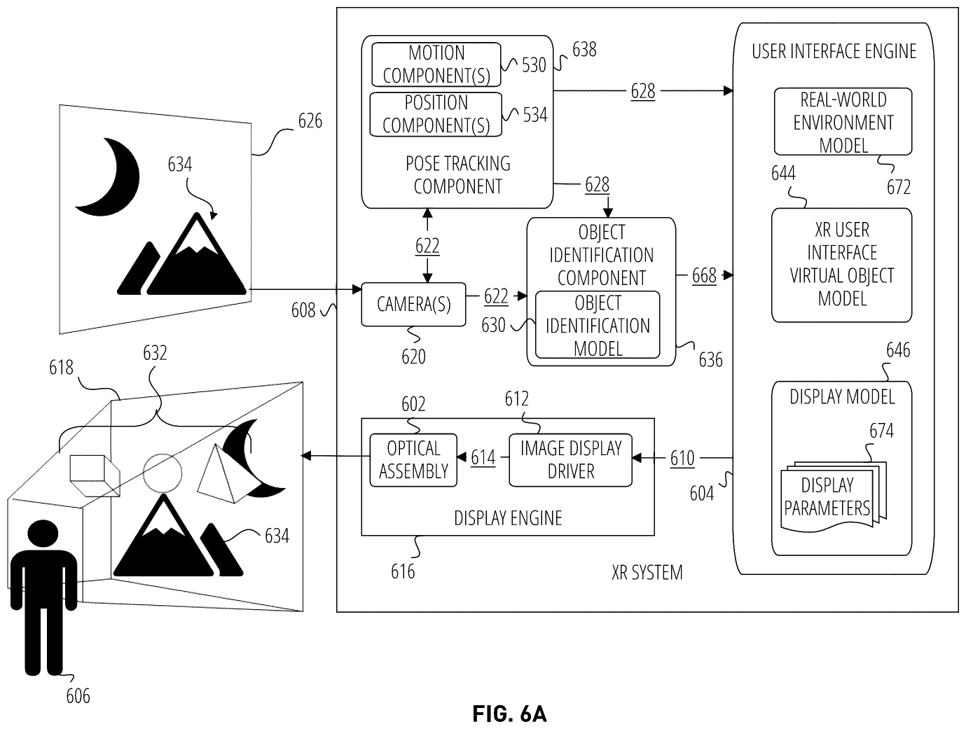

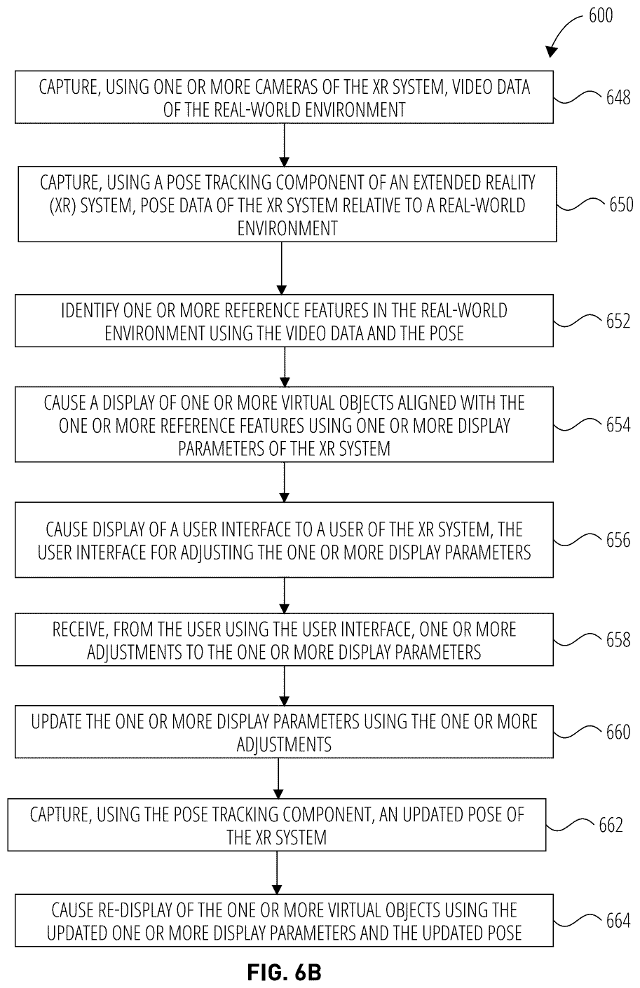

FIG. 6A is a collaboration diagram of components of an XR system 608 and FIG. 6B is a process flow diagram of a display parameter calibration method 600 of the XR system 608, in accordance with some examples. Although the display parameter calibration method 600 depicts a particular sequence of operations, the sequence of operations may be altered without departing from the scope of the present disclosure. For example, some of the operations depicted may be performed in parallel, in a different sequence, or by different components of an XR system, without materially affecting the function of the display parameter calibration method 600.

Geometric parameters of a head-wearable apparatus and user-centric parameters related to a user of the head-wearable apparatus can affect how virtual objects are displayed by left and right optical elements of the head-wearable apparatus. These factors interact in complex ways to influence the user's perception of augmented or virtual content.

In some examples, geometric parameters of a frame of a head-wearable apparatus can be affected by various forces acting on the frame. For example, the frame can be subject to bending and torque forces during normal use, potentially causing misalignments of the optical elements. As another example, the left and right optical element holders may shift slightly relative to each other, altering the intended alignment of displayed content. This can result in virtual objects appearing offset or distorted to the user. The frame's material properties and construction play a role in its susceptibility to deformation.

In some examples, user-centric parameters, such as inter-pupillary distance (IPD), affect the proper alignment of virtual content. For example, IPD varies between individuals, and if not accurately accounted for, can lead to incorrect depth perception and eye strain. The XR system may need to adjust the rendering of virtual objects based on the user's specific IPD to ensure proper stereoscopic alignment. In addition, how a user positions the head-wearable apparatus on their head also impacts the display of virtual objects. Slight variations in the device's position relative to the user's eyes can affect the perceived location and scale of virtual content. For instance, if the device sits higher or lower on the nose bridge than intended, it may cause vertical misalignment of virtual objects relative to the real world.

User calibration processes can be implemented to fine-tune display parameters based on individual characteristics and preferences. Additionally, an XR system may incorporate a display model 646 that accounts for various geometric and user-centric parameters. This model can be dynamically updated based on sensor data and user input to maintain accurate rendering of virtual objects across different usage scenarios and environmental conditions. By addressing these factors, an XR system can provide a consistent and accurate display of virtual objects, enhancing the user experience and maintaining the illusion of seamless integration between virtual and real-world elements.

The display parameter calibration method 600 is used by an XR system 608 to provide user-assisted calibration of a display model 646. The XR system 608 provides an XR user interface 618 to the user 606 where the XR user interface 618 is generated by a user interface engine 604 of the XR system 608.

In some examples, the display model 646 comprises a model of the physical and logical components of the display engine 616. The display model 646 is used by the user interface engine 604 when generating XR user interface graphics data 610 from the XR user interface virtual object model 644 to ensure that the virtual objects of the XR user interface virtual object model 644 are properly rendered by the display engine 616. For example, the display model 646 can include display parameters 674 such as an IPD adjustment parameter, a vertical offset adjustment parameter, a horizontal offset adjustment parameter, a left-right asymmetry adjustment parameter, a prescription insert adjustment parameter, and the like. These display parameters are used to adjust how virtual objects are rendered on optical elements of a head-wearable apparatus, such as head-wearable apparatus 100 (of FIG. 1A) comprising the XR system. This improves the alignment of virtual objects with the user's vision and a real-world environment 626.

In some examples, the display model 646 comprises various adjustment parameters to address both geometric parameters and user-centric parameters in an XR system. The IPD adjustment parameter is a user-centric parameter that accounts for the distance between a user's pupils. The vertical offset adjustment parameter and horizontal offset adjustment parameter are both geometric and user-centric parameters, addressing how the device is positioned on the user's head and potential frame deformation. The left-right asymmetry adjustment parameter is also both geometric and user-centric, accounting for potential frame deformation and asymmetries in the user's facial structure. The prescription insert adjustment parameter is a user-centric parameter that compensates for prescription lenses inserted into the XR system. These parameters collectively allow the XR system to adapt to individual user characteristics and potential physical variations in a head-wearable apparatus, ensuring proper alignment and display of virtual objects in the augmented or virtual environment.

In some examples, the display model 646 can comprise information about the optical characteristics of the display engine 616, such as field of view, resolution, and any distortion correction needed for the specific optical assembly 602 being used.

In some examples, the display model 646 accounts for the pose of the XR system relative to the real-world environment, as determined by the pose tracking component 638. This integration allows the XR system to maintain proper alignment of virtual objects with real-world reference features as the user moves and changes their viewpoint.

In operation 648, the XR system captures video data 622 of the real-world environment 626 using one or more cameras 620 of the XR system. For example, the XR system uses the one or more cameras 620 mounted on the XR user device to capture the real-world environment 626 from a perspective of the user 606. The one or more cameras 620 communicate the video data 622 to a user interface engine 604. In some examples, the one or more cameras 620 also communicate the video data 622 to the pose tracking component 638.

In operation 650, the XR system captures, using a pose tracking component 638 of the XR system, pose data 628 of the XR system relative to a real-world environment 626. For example, the pose tracking component 638 of the XR system can utilize one or more motion components 530, one or more position components 534, and one or more processes to determine a position and orientation of the XR system relative to the real-world environment.

In some examples, the one or more position components 534 may include an Inertial Measurement Unit (IMU) that provides Six Degrees of Freedom (6DoF) data, capturing three translational movements (forward/back, up/down, left/right) and three rotational movements (pitch, yaw, roll) of the XR system. In some examples, the pose tracking component 638 can use one or more cameras 620 to capture video data 622 of the real-world environment 626 which then analyzed using computer vision techniques such as visual-inertial odometry or simultaneous localization and mapping (SLAM) to determine the XR system's pose. The pose data 628 generated by the pose tracking component 638 is used in conjunction with the display model 646 to accurately render virtual objects in a correct position and orientation within the user's view of the real-world environment, enabling proper alignment between virtual objects and real-world reference features.

In operation 652, the XR system identifies one or more reference features in the real-world environment using the video data and the pose data. For example, the XR system can utilize computer vision techniques to analyze the video data 622 captured by the one or more cameras 620 of the XR system and identify distinctive features or patterns in the real-world environment 626 that can be used as reference features. These reference features can include corners, edges, surfaces of physical objects, and the like.

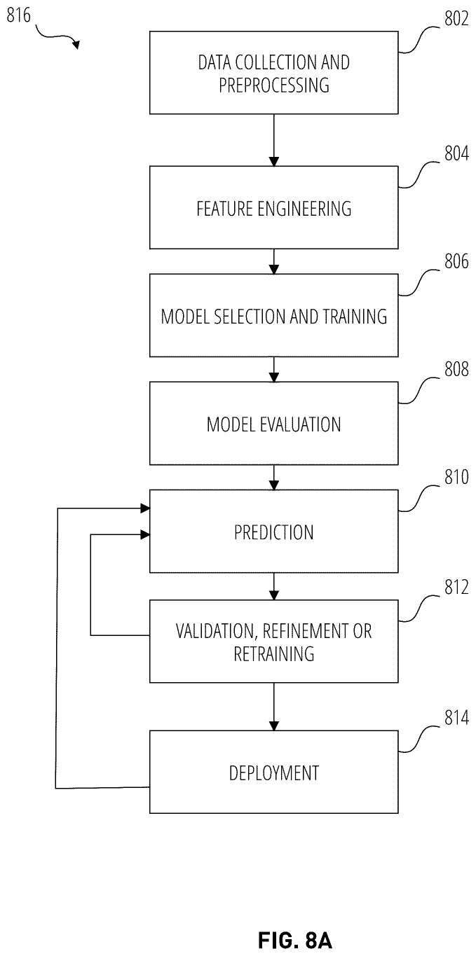

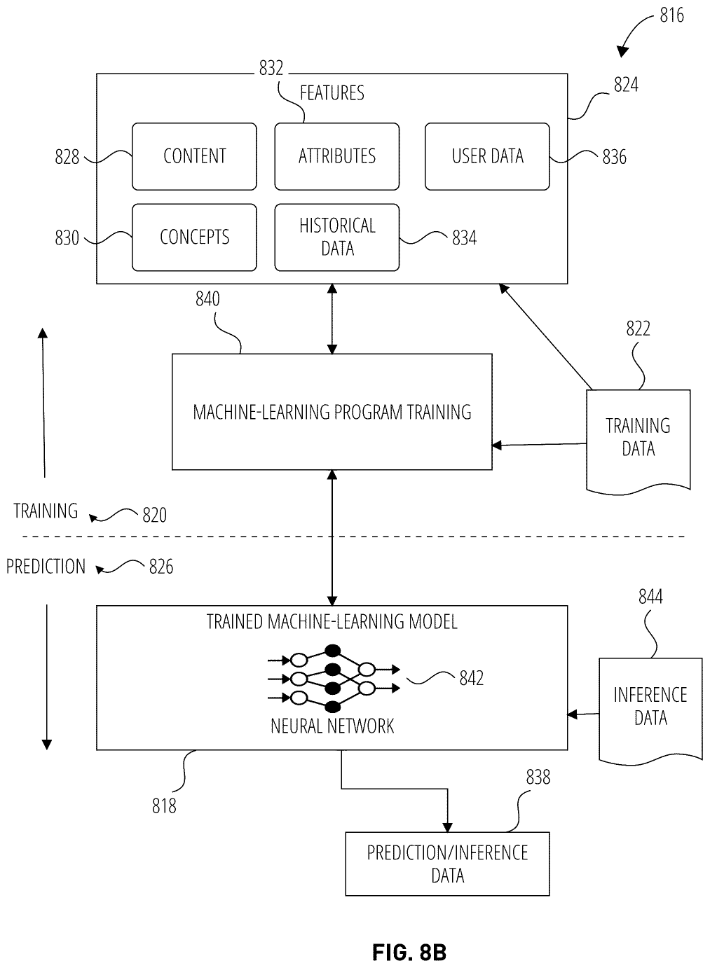

In some examples, the object identification component 636 of the XR system can employ artificial intelligence methodologies and an object identification model 630 to detect and label physical objects within the video frames. The object identification model may be implemented using various machine learning approaches such as convolutional neural networks, support vector machines, or random decision forests as more fully described in reference to FIG. 8A and FIG. 8B.

In some examples, the object identification model 630 identifies physical features of the real-world environment 626 that are not complete physical objects, such as a floor surface of a room, an inside corner of a room, an outside corner of a building, a tabletop of a table that is not fully framed in a the video data 622, and the like. The detected physical features of the real-world environment 626 may be used for the same purposes as detected physical objects 634 of the real-world environment 626.

The object identification component 636 combines the identified physical objects from the video data 622 with the pose data 628 obtained from the pose tracking component to generate real-world environment data 668 containing object identifications of one or more physical objects 634 in the real-world environment 626 and 3D data about the location and position of the identified one or more physical objects 634. The user interface engine 604 receives the real-world environment data 668 and constructs and maintains a real-world environment model 672 of the real-world environment 626. The real-world environment model 672 is a 3D model of a volume of space in the real-world environment 626 in which virtual objects 632 will be displayed to the user 606. The real-world environment model 672 includes 3D position data of the virtual objects 632.

In some examples, when generating the virtual objects 632, the user interface engine 604 uses the 3D positions of the detected physical objects 634 of the real-world environment 626 and modeled in the real-world environment model 672 to determine 3D anchor points within the real-world environment 626 that are used to set the 3D positions of the virtual objects 632 in the XR user interface 618 relative to the physical objects 634 of the real-world environment 626. By doing so, the virtual objects 632 appear to the user 606 as if the virtual objects 632 are fixed physical objects in the real-world environment 626.

In some examples, when the virtual objects 632 are rendered by the XR system, the XR system uses the display model 646 to accurately render the virtual objects 632 in a corrected position and orientation within the user's view of the real-world environment, enabling proper alignment between the virtual objects 632 and the physical objects 634 and features of the real-world environment.

In some examples, the virtual objects 632 are provided to the user in a binocular display such that the user 606 perceives the virtual objects 632 as being positioned in the real-world environment 626 at the 3D anchor points. In addition, the user interface engine 604 identifies one or more reference features based on the one or more physical objects 634. The reference features serve as a basis for aligning the virtual objects 632 of the XR user interface 618 with the real-world environment 626 during a calibration.

In some examples, the XR system receives from the user a designation of specific reference features in the real-world environment 626. For example, the XR system can allow the user to designate specific reference features in the real-world environment 626 as part of the process of identifying reference features for alignment. This user-driven approach to selecting reference features can provide greater flexibility and precision in the calibration process.

In some examples, the user may be prompted to trace the outline of specific physical objects or features in the real-world environment, such as a table, door, or other well-defined physical objects or features. The XR system receives from the user a designation of the physical objects or features and generates user-designated reference features using the designated physical objects and features. The XR system uses the user-designated reference features when aligning virtual objects during a calibration process.

In some examples, the XR systems provides guidance to the user on selecting appropriate reference features, such as choosing features that are well-defined in terms of position in the real world.

In some examples, the user designation of reference features can be combined with the XR system's automatic determination of reference features to create a more comprehensive and accurate set of reference features for alignment.

By allowing user designation of reference features, the XR system can accommodate a wide range of environments and user preferences, potentially improving the accuracy and effectiveness of the calibration process.

In operation 654, the XR system causes a display of one or more virtual objects aligned with the one or more reference features using one or more display parameters 674 of the XR system. For example, the XR system utilizes the display engine 616 to generate an overlay of the real-world environment 626, including the display of an XR user interface 618 comprising one or more calibration virtual objects to the user 606 of the XR system. The user interface engine 604 generates XR user interface graphics data 610 of the one or more calibration virtual objects using an XR user interface virtual object model 644 which includes 3D coordinate data and 3D graphics data of the one or more calibration virtual objects. This data is then communicated to the image display driver 612 of the display engine 616. The display driver receives the XR user interface graphics data 610 and generates display control signals 614 using the XR user interface graphics data 610.The display control signals 614 are used to control the operations of an optical assembly 602 of the display engine 616. The optical assembly 602 includes a left optical element and right optical element as more fully described in reference to FIG. 1A and FIG. 1B. When a virtual object is displayed to a user, a left rendering of the virtual object is displayed on the left optical element and a right rendering of the virtual object is displayed to a user on the right optical element. When a user views the real-world environment 626 through the left optical element and the right optical element, the rendered virtual object will appear as a 3D virtual object within the real-world environment 626. In response to the display control signals 614 signals, the optical assembly 602 generates visible images of the XR user interface 618, including rendered images of the one or more calibration virtual objects which are then provided to the user 606 in the XR user interface 618.

The XR system uses the 3D positions of the one or more reference features to determine 3D anchor points within the real-world environment 626 for the one or more calibration virtual objects. These anchor points are used to set the 3D positions of the one or more calibration virtual objects in the XR user interface 618 aligned to one or more detected physical objects or features of the real-world environment 626. This process ensures that the one or more calibration virtual objects appear to the user 606 as if they are fixed physical objects in the real-world environment 626. The one or more calibration virtual objects are provided to the user in a binocular display using the left optical element and the right optical element, allowing the user to perceive the one or more calibration virtual objects as being positioned in the real-world environment 626 at the 3D anchor points.

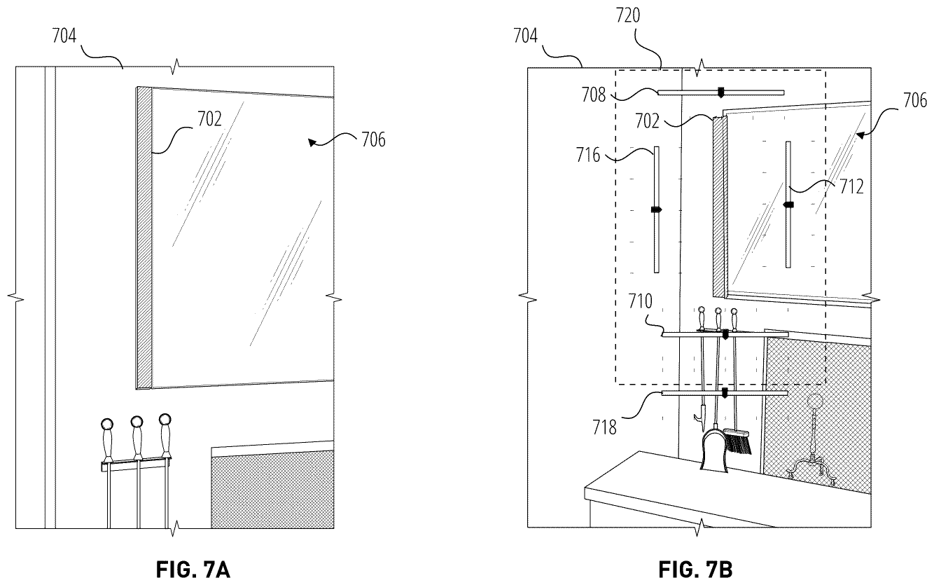

For example, in reference to FIG. 7A, a calibration virtual object 702 is rendered by the XR system as being aligned with a physical object 706 of the real-world environment 704 by one or more reference features. In some examples, a physical object can be a feature of the real-world environment 704 such as a corner formed by two intersecting walls or other surfaces, a surface of a wall or a table having distinctive elements such as ornamentation, or the like.

In operation 656, the XR system causes display of a calibration user interface to a user of the XR system, the calibration user interface for adjusting the one or more display parameters. For example, in reference to FIG. 7B, the XR system utilizes the user interface engine 604 to generate and display a calibration user interface 720 that allows the user to adjust one or more display parameters 674.

In some examples, the calibration user interface includes interactive virtual objects such as virtual sliders, controls, or the like that can be used by the user to enter one or more adjustments to the display parameters 674. For example, an interactive virtual object for an IPD adjustment 708 can be provided for setting an IPD adjustment parameter. Adjustment of the IPD can enhance the user's depth perception of the calibration virtual object 702. The calibration user interface can include an interactive virtual object for a vertical offset adjustment 712 that a user can use to set a vertical offset adjustment parameter for adjusting a vertical offset of the calibration virtual object 702 as it appears to the user. The calibration user interface can include an interactive virtual object for a horizontal offset adjustment 710 that the user can set a horizontal offset adjustment parameter that helps correct a horizontal misalignment of the calibration virtual object 702. The calibration user interface can include an interactive virtual object for a left-right asymmetry adjustment 716 that can be used to set a left-right asymmetry adjustment parameter that adjusts for misalignment of a left optical element and a right optical element relative to each other. The calibration user interface can include an interactive virtual object for a prescription insert adjustment 718 that can be used to set a prescription insert adjustment parameter for compensating for a user wearing prescription lenses.

In some examples, the calibration user interface can take various forms depending on the specific implementation of the XR system. For example, the user can be prompted to interact directly with the calibration virtual object 702 by moving selecting the calibration virtual object 702 and moving the calibration virtual object 702 from side to side, up and down, and in and out relative to the frame of reference of the user until the calibration virtual object 702 is properly aligned with one or more reference features to the user's satisfaction. In some examples, XR system provides the calibration user interface 720 with a Direct Manipulation of Virtual Object (DMVO) user input modality that allows the user to use pinching or grabbing motions at the location of the calibration virtual object 702 to select and move the calibration virtual object 702, In some examples, the XR system provides a user input modality that includes a raycast cursor user input modality for the user to use in selecting and moving the calibration virtual object 702. In some examples, the XR system provides a hand gesture user input modality that a user may use to select and move the calibration virtual object 702.

In some examples, the calibration user interface may be presented as a set of virtual menus or controls within the XR environment itself, which the user can interact with using hand gestures or other input methods.

In some examples, the calibration user interface for adjusting display parameters can be provided through a companion device, such as an application on a mobile device such as a smartphone or the like linked to the XR system. This approach allows the user to make adjustments using familiar controls while observing the effects in real-time through the optical elements of the XR system.

In operation 658, the XR system receives, from the user, using the calibration user interface 720, one or more adjustments to the one or more display parameters 674 and, in operation 660, the XR system updates the one or more display parameters 674 using the one or more adjustments. For example, the user interacts with virtual sliders or controls, such as IPD adjustment 708, horizontal offset adjustment 710, vertical offset adjustment 712, left-right asymmetry adjustment 716, and prescription insert adjustment 718, of the calibration user interface 720, using hand gestures or other input methods to make adjustments. As the user makes these adjustments, the XR system continuously captures and processes these adjustments to the display parameters 674 in real-time. The XR system determines a value of an adjustment to the associated display parameter and applies the adjustment to a corresponding display parameter of the one or more display parameters 674.

In some examples, the calibration user interface 720 can provide visual feedback or guidance to help the user understand how to adjust the display parameters 674 for optimal alignment of the calibration virtual object 702 to the physical object 706.

In some examples, an adjustment to a display parameter comprises one or more offsets in a number of pixels applied to a rendering of a virtual object on a left optical element and a right optical element of the optical assembly 602. For example, in case of an IPD display parameter adjustment, the renderings of the virtual object are moved inward toward each other by a specified number of pixels to make it appear that the virtual object is further away and outward away from each other by a specified number of pixels in order to make it appear that the virtual object is closer.

In some examples, in a case of a vertical offset parameter adjustment, the renderings of the virtual object on both the left optical element and the right optical element are moved up by a specified number of pixels to make the virtual object appear to be higher in the real-world environment. Conversely, the renderings of the virtual object on both the left optical element and the right optical element are moved down by a specified number of pixels to make the virtual object appear to be lower in the real-world environment.

In some examples, in a case of a horizontal offset adjustment display parameter, the renderings of the virtual object on both the left optical element and the right optical element are moved leftward from the perspective of the user by a specified number of pixels to make the virtual object appear to be further left in the real-world environment. Conversely, the renderings of the virtual object on both the left optical element and the right optical element are moved rightward from the perspective of the user by a specified number of pixels to make the virtual object appear to be further right in the real-world environment.

In some examples, in a case of a prescription insert compensation, the renderings of the virtual object on both the left optical element and the right optical element are expanded or reduced by a specified number of pixels horizontally and vertically.

In some examples, in a case of a left-right asymmetry adjustment display parameter, vertical and/or horizontal pixel offsets are applied to renderings of a virtual object in both a left optical element and a right optical element independently of each other. For example, a left rendering displayed by a left optical element may be moved upward by a specified number of pixels so that the left rendering of the virtual object appears higher to the user while a right rendering of the virtual object is moved downward by a specified number of pixels.

In some examples, one or more pose adjustment display parameters are used by the XR system to correct for a pose of the XR system relative to the real-world environment when a virtual object is rendered.

In some examples, one or more size adjustment display parameters are used by the XR system to correct for a size of a virtual object when the virtual object is rendered.

In some examples, one or more position adjustment display parameters are used by the XR system to correct for a position of a virtual object when the virtual object is rendered.

In some examples, one or more shape adjustment display parameters are used by the XR system to correct for a size of a virtual object when the virtual object is rendered.

In some examples, the XR system applies one or more adjustment display parameters to different portions of a virtual object different based on the portion's relative position to the user's eyes and the optical elements of the XR system.

In some examples, adjustments to a rendering may not be uniform across the entire virtual object. The rendering process may apply varying levels of correction to different parts of the object to account for distortions in the optical system or to maintain proper perspective.

In operation 662, the XR system captures, using the pose tracking component 638, an updated pose of the XR system and, in operation 664, the XR system causes re-display of the one or more virtual objects using the updated one or more display parameters and the updated pose. The updated pose data reflects any changes in the position or orientation of the XR system that may have occurred since the initial pose was captured. The XR system uses this updated pose data along with the newly adjusted display parameters 674 to re-render and re-display the virtual objects being used for calibration. The user interface engine 604 generates updated XR user interface graphics data 610 incorporating both the updated display parameters 674 and the updated pose data 628. The XR user interface graphics data 610 is communicated to the display engine 616, which uses the XR user interface graphics data 610 to render the virtual objects with improved alignment and positioning relative to the real-world environment 626.

The process of capturing an updated pose and re-displaying a calibration virtual object while the user enters adjustments to one or more display parameters ensures that alignments between virtual objects in an XR environment and physical objects of a real-world environment remain accurate even as the user moves or changes their viewpoint within the XR environment and the real-world environment. This continuous updating allows the user to observe the effects of their display parameter adjustments from multiple perspectives, facilitating a more comprehensive and accurate calibration process.

In some examples, the XR system can provide instructions to the user through the calibration user interface 720 to move the XR system and observe the alignment of the calibration virtual object 702 with the real-world environment reference features from multiple viewpoints in an iterative process. As the user moves, the XR system continuously updates the rendering of the calibration virtual object 702 based on the current pose data 628 of the XR system, allowing real-time observation of alignment accuracy. This iterative process allows the user to assess the accuracy of the alignment from different angles and distances, ensuring a more comprehensive calibration. For example, the XR system guides the user to move closer to or further away from the calibration virtual object 702, or to view the calibration virtual object 702 from different angles while making adjustments to the display parameters 674. This multi-viewpoint approach helps identify any discrepancies in alignment that may only be apparent from certain perspectives.

In some examples, the calibration user interface 720 may provide visual cues or prompts to guide the user's movement, such as arrows indicating suggested directions or highlighting specific areas of interest. This process of instructing the user to move and observe from multiple viewpoints is useful for achieving accurate calibration, as it helps account for potential variations in alignment across different spatial positions and viewing angle and allows the user to fine-tune the display parameters 674 more effectively, ensuring that the virtual content remains properly aligned with the real-world environment regardless of the user's position or orientation.

FIG. 8A illustrates phases of training and use of a machine-learning pipeline 816, and FIG. 8B illustrates a flowchart depicting a machine-learning pipeline 816, according to some examples. The machine-learning pipeline 816 can be used to generate a trained machine-learning model 818 such as, but not limited to an object identification model 630 of FIG. 6A, and the like, to perform operations associated with determining inputs into an XR system.

Machine learning can involve using computer algorithms to automatically learn patterns and relationships in data, potentially without the need for explicit programming. Machine learning algorithms can be divided into three main categories: supervised learning, unsupervised learning, and reinforcement learning.
Supervised learning involves training a model using labeled data to predict an output for new, unseen inputs. Examples of supervised learning algorithms include linear regression, decision trees, and neural networks.
Unsupervised learning involves training a model on unlabeled data to find hidden patterns and relationships in the data. Examples of unsupervised learning algorithms include clustering, principal component analysis, and generative models like autoencoders.
Reinforcement learning involves training a model to make decisions in a dynamic environment by receiving feedback in the form of rewards or penalties. Examples of reinforcement learning algorithms include Q-learning and policy gradient methods.

Examples of specific machine learning algorithms that can be deployed, according to some examples, include logistic regression, which is a type of supervised learning algorithm used for binary classification tasks. Logistic regression models the probability of a binary response variable based on one or more predictor variables. Another example type of machine learning algorithm is Naïve Bayes, which is another supervised learning algorithm used for classification tasks. Naïve Bayes is based on Bayes' theorem and assumes that the predictor variables are independent of each other. Random Forest is another type of supervised learning algorithm used for classification, regression, and other tasks. Random Forest builds a collection of decision trees and combines their outputs to make predictions. Further examples include neural networks, which consist of interconnected layers of nodes (or neurons) that process information and make predictions based on the input data. Matrix factorization is another type of machine learning algorithm used for recommender systems and other tasks. Matrix factorization decomposes a matrix into two or more matrices to uncover hidden patterns or relationships in the data. Support Vector Machines (SVM) are a type of supervised learning algorithm used for classification, regression, and other tasks. SVM finds a hyperplane that separates the different classes in the data. Other types of machine learning algorithms include decision trees, k-nearest neighbors, clustering algorithms, and deep learning algorithms such as convolutional neural networks (CNN), recurrent neural networks (RNN), and transformer models. The choice of algorithm depends on the nature of the data, the complexity of the problem, and the performance requirements of the application.

The performance of machine learning models is typically evaluated on a separate test set of data that was not used during training to ensure that the model can generalize to new, unseen data.

Although several specific examples of machine learning algorithms are discussed herein, the principles discussed herein can be applied to other machine learning algorithms as well. Deep learning algorithms such as convolutional neural networks, recurrent neural networks, and transformers, as well as more traditional machine learning algorithms like decision trees, random forests, and gradient boosting can be used in various machine learning applications.

Three example types of problems in machine learning are classification problems, regression problems, and generation problems. Classification problems, also referred to as categorization problems, aim at classifying items into one of several category values (for example, is this object an apple or an orange?). Regression algorithms aim at quantifying some items (for example, by providing a value that is a real number). Generation algorithms aim at producing new examples that are similar to examples provided for training. For instance, a text generation algorithm is trained on many text documents and is configured to generate new coherent text with similar statistical properties as the training data.

Generating a trained machine-learning model 818 can include multiple phases that form part of the machine-learning pipeline 816, including for example the following phases illustrated in FIG. 8A:
Data collection and preprocessing 802: This phase can include acquiring and cleaning data to ensure that it is suitable for use in the machine learning model. This phase can also include removing duplicates, handling missing values, and converting data into a suitable format.
Feature engineering 804: This phase can include selecting and transforming the training data 822 to create features that are useful for predicting the target variable. Feature engineering can include (1) receiving features 824 (e.g., as structured or labeled data in supervised learning) and/or (2) identifying features 824 (e.g., unstructured or unlabeled data for unsupervised learning) in training data 822.
Model selection and training 806: This phase can include selecting an appropriate machine learning algorithm and training it on the preprocessed data. This phase can further involve splitting the data into training and testing sets, using cross-validation to evaluate the model, and tuning hyperparameters to improve performance.
Model evaluation 808: This phase can include evaluating the performance of a trained model (e.g., the trained machine-learning model 818) on a separate testing dataset. This phase can help determine if the model is overfitting or underfitting and determine whether the model is suitable for deployment.
Prediction 810: This phase involves using a trained model (e.g., trained machine-learning model 818) to generate predictions on new, unseen data.
Validation, refinement or retraining 812: This phase can include updating a model based on feedback generated from the prediction phase, such as new data or user feedback.
Deployment 814: This phase can include integrating the trained model (e.g., the trained machine-learning model 818) into a more extensive system or application, such as a web service, mobile app, or IoT device. This phase can involve setting up APIs, building a user interface, and ensuring that the model is scalable and can handle large volumes of data.

FIG. 8B illustrates further details of two example phases, namely a training phase 820 (e.g., part of the model selection and trainings 806) and a prediction phase 826 (part of prediction 810). Prior to the training phase 820, feature engineering 804 is used to identify features 824. This can include identifying informative, discriminating, and independent features for effectively operating the trained machine-learning model 818 in pattern recognition, classification, and regression. In some examples, the training data 822 includes labeled data, known for pre-identified features 824 and one or more outcomes. Each of the features 824 can be a variable or attribute, such as an individual measurable property of a process, article, system, or phenomenon represented by a data set (e.g., the training data 822). Features 824 can also be of different types, such as numeric features, strings, and graphs, and can include one or more of content 828, concepts 830, attributes 832, historical data 834, and/or user data 836, merely for example.

In training phase 820, the machine-learning pipeline 816 uses the training data 822 to find correlations among the features 824 that affect a predicted outcome or prediction/inference data 838.

With the training data 822 and the identified features 824, the trained machine-learning model 818 is trained during the training phase 820 during machine-learning program training 840. The machine-learning program training 840 appraises values of the features 824 as they correlate to the training data 822. The result of the training is the trained machine-learning model 818 (e.g., a trained or learned model).

Further, the training phase 820 can involve machine learning, in which the training data 822 is structured (e.g., labeled during preprocessing operations). The trained machine-learning model 818 implements a neural network 842 capable of performing, for example, classification and clustering operations. In other examples, the training phase 820 can involve deep learning, in which the training data 822 is unstructured, and the trained machine-learning model 818 implements a deep neural network 842 that can perform both feature extraction and classification/clustering operations.

In some examples, a neural network 842 can be generated during the training phase 820, and implemented within the trained machine-learning model 818. The neural network 842 includes a hierarchical (e.g., layered) organization of neurons, with each layer consisting of multiple neurons or nodes. Neurons in the input layer receive the input data, while neurons in the output layer produce the final output of the network. Between the input and output layers, there can be one or more hidden layers, each consisting of multiple neurons.

Each neuron in the neural network 842 operationally computes a function, such as an activation function, which takes as input the weighted sum of the outputs of the neurons in the previous layer, as well as a bias term. The output of this function is then passed as input to the neurons in the next layer. If the output of the activation function exceeds a certain threshold, an output is communicated from that neuron (e.g., transmitting neuron) to a connected neuron (e.g., receiving neuron) in successive layers. The connections between neurons have associated weights, which define the influence of the input from a transmitting neuron to a receiving neuron. During the training phase, these weights are adjusted by the learning algorithm to optimize the performance of the network. Different types of neural networks can use different activation functions and learning algorithms, affecting their performance on different tasks. The layered organization of neurons and the use of activation functions and weights enable neural networks to model complex relationships between inputs and outputs, and to generalize to new inputs that were not seen during training.

In some examples, the neural network 842 can also be one of several different types of neural networks, such as a single-layer feed-forward network, a Multilayer Perceptron (MLP), an Artificial Neural Network (ANN), a Recurrent Neural Network (RNN), a Long Short-Term Memory Network (LSTM), a Bidirectional Neural Network, a symmetrically connected neural network, a Deep Belief Network (DBN), a Convolutional Neural Network (CNN), a Generative Adversarial Network (GAN), an Autoencoder Neural Network (AE), a Restricted Boltzmann Machine (RBM), a Hopfield Network, a Self-Organizing Map (SOM), a Radial Basis Function Network (RBFN), a Spiking Neural Network (SNN), a Liquid State Machine (LSM), an Echo State Network (ESN), a Neural Turing Machine (NTM), or a Transformer Network, merely for example.

In addition to the training phase 820, a validation phase can be performed on a separate dataset known as the validation dataset. The validation dataset is used to tune the hyperparameters of a model, such as the learning rate and the regularization parameter. The hyperparameters are adjusted to improve the model's performance on the validation dataset.

Once a model is fully trained and validated, in a testing phase, the model can be tested on a new dataset. The testing dataset is used to evaluate the model's performance and ensure that the model has not overfitted the training data.

In prediction phase 826, the trained machine-learning model 818 uses the features 824 for analyzing inference data 844 to generate inferences, outcomes, or predictions, as examples of a prediction/inference data 838. For example, during prediction phase 826, the trained machine-learning model 818 generates an output. Inference data 844 is provided as an input to the trained machine-learning model 818, and the trained machine-learning model 818 generates the prediction/inference data 838 as output, responsive to receipt of the inference data 844.

In some examples, the trained machine-learning model 818 can be a generative AI model. Generative AI is a term that can refer to any type of artificial intelligence that can create new content from training data 822. For example, generative AI can produce text, images, video, audio, code, or synthetic data similar to the original data but not identical. In cases where the trained machine-learning model 818 is a generative AI, inference data 844 can include text, audio, image, video, numeric, or media content prompts and the output prediction/inference data 838 can include text, images, video, audio, code, or synthetic data.

Some of the techniques that can be used in generative AI are:
Convolutional Neural Networks (CNNs): CNNs can be used for image recognition and computer vision tasks. CNNs can, for example, be designed to extract features from images by using filters or kernels that scan the input image and highlight important patterns.
Recurrent Neural Networks (RNNs): RNNs can be used for processing sequential data, such as speech, text, and time series data, for example. RNNs employ feedback loops that allow them to capture temporal dependencies and remember past inputs.
Generative adversarial networks (GANs): GANs can include two neural networks: a generator and a discriminator. The generator network attempts to create realistic content that can “fool” the discriminator network, while the discriminator network attempts to distinguish between real and fake content. The generator and discriminator networks compete with each other and improve over time.
Variational autoencoders (VAEs): VAEs can encode input data into a latent space (e.g., a compressed representation) and then decode it back into output data. The latent space can be manipulated to generate new variations of the output data. VAEs can use self-attention mechanisms to process input data, allowing them to handle long text sequences and capture complex dependencies.
Transformer models: Transformer models can use attention mechanisms to learn the relationships between different parts of input data (such as words or pixels) and generate output data based on these relationships. Transformer models can handle sequential data, such as text or speech, as well as non-sequential data, such as images or code.

Described implementations of the subject matter can include one or more features, alone or in combination as illustrated below by way of example.

Example 1 is a machine-implemented method comprising: capturing, using a pose tracking component of an extended Reality (XR) system, pose data of the XR system relative to a real-world environment; capturing, using one or more cameras of the XR system, video data of the real-world environment; identifying one or more reference features in the real-world environment using the video data and the pose data; causing a display of one or more virtual objects aligned with the one or more reference features using one or more display parameters of the XR system; causing display of a user interface to a user of the XR system, the user interface for adjusting the one or more display parameters; receiving, from the user using the user interface, one or more adjustments to the one or more display parameters; updating the one or more display parameters using the one or more adjustments; capturing, using the pose tracking component, an updated pose of the XR system; and causing re-display of the one or more virtual objects using the updated one or more display parameters and the updated pose.

In Example 2, the subject matter of Example 1 includes, wherein the one or more display parameters comprise an Inter-Pupillary Distance (IPD) adjustment display parameter.

In Example 3, the subject matter of any of Examples 1-2 includes, wherein the one or more display parameters comprise at least one of a vertical offset adjustment display parameter, a horizontal offset adjustment display parameter, a left-right asymmetry adjustment display parameter, or a prescription insert adjustment display parameter.

In Example 4, the subject matter of any of Examples 1-3 includes, wherein identifying the one or more reference features comprises receiving from the user a designation of specific reference features in the real-world environment.

In Example 5, the subject matter of any of Examples 1-4 includes, wherein causing display of the user interface comprises instructing the user to move the XR system and observe an alignment of the one or more virtual objects with the one or more reference features from multiple viewpoints.

In Example 6, the subject matter of any of Examples 1-5 includes, wherein the display parameters are part of a display model incorporating the one or more display parameters used to optimize virtual object alignment in an XR environment.

In Example 7, the subject matter of any of Examples 1-6 includes, wherein the XR system is a head-wearable apparatus.

Example 8 is at least one machine-readable medium including instructions that, when executed by processing circuitry, cause the processing circuitry to perform operations to implement of any of any of Examples 1-7.

Example 9 is an apparatus comprising means to implement any of Examples 1-7.

Example 10 is a system to implement any of Examples 1-7.

Example 11 is a method to implement any of Examples 1-7.

The various features, operations, or processes described herein can be used independently of one another, or can be combined in various ways. All possible combinations and sub-combinations are intended to fall within the scope of this disclosure. In addition, certain method or process blocks can be omitted in some implementations.

Although some examples, e.g., those depicted in the drawings, include a particular sequence of operations, the sequence can be altered without departing from the scope of the present disclosure. For example, some of the operations depicted can be performed in parallel or in a different sequence that does not materially affect the functions as described in the examples. In other examples, different components of an example device or system that implements an example method can perform functions at substantially the same time or in a specific sequence.

Changes and modifications can be made to the disclosed examples without departing from the scope of the present disclosure. These and other changes or modifications are intended to be included within the scope of the present disclosure, as expressed in the appended claims.

### Term Examples

As used in this disclosure, phrases of the form “at least one of an A, a B, or a C,” “at least one of A, B, or C,” “at least one of A, B, and C,” and the like, should be interpreted to select at least one from the group that comprises “A, B, and C.” Unless explicitly stated otherwise in connection with a particular instance in this disclosure, this manner of phrasing does not mean “at least one of A, at least one of B, and at least one of C.” As used in this disclosure, the example “at least one of an A, a B, or a C,” would cover any of the following selections: {A}, {B}, {C}, {A, B}, {A, C}, {B, C}, and {A, B, C}.

Unless the context clearly requires otherwise, throughout the description and the claims, the words “comprise,” “comprising,” and the like are to be construed in an inclusive sense, as opposed to an exclusive or exhaustive sense, e.g., in the sense of “including, but not limited to.”

As used herein, the terms “connected,” “coupled,” or any variant thereof means any connection or coupling, either direct or indirect, between two or more elements; the coupling or connection between the elements can be physical, logical, or a combination thereof.

Additionally, the words “herein,” “above,” “below,” and words of similar import, when used in this application, refer to this application as a whole and not to any portions of this application. Where the context permits, words using the singular or plural number can also include the plural or singular number respectively.

The word “or” in reference to a list of two or more items, covers all the following interpretations of the word: any one of the items in the list, all the items in the list, and any combination of the items in the list. Likewise, the term “and/or” in reference to a list of two or more items, covers all the following interpretations of the word: any one of the items in the list, all the items in the list, and any combination of the items in the list.

“Carrier signal” can include, for example, any intangible medium that can store, encoding, or carrying instructions for execution by the machine and includes digital or analog communications signals or other intangible media to facilitate communication of such instructions. Instructions can be transmitted or received over a network using a transmission medium via a network interface device.

“Client device” can include, for example, any machine that interfaces to a network to obtain resources from one or more server systems or other client devices. A client device can be, but is not limited to, a mobile phone, desktop computer, laptop, portable digital assistants (PDAs), smartphones, tablets, ultrabooks, netbooks, laptops, multi-processor systems, microprocessor-based or programmable consumer electronics, game consoles, set-top boxes, or any other communication device that a user can use to access a network.

“Component” can include, for example, a device, physical entity, or logic having boundaries defined by function or subroutine calls, branch points, APIs, or other technologies that provide for the partitioning or modularization of particular processing or control functions. Components can be combined via their interfaces with other components to carry out a machine process. A component can be a packaged functional hardware unit designed for use with other components and a part of a program that usually performs a particular function of related functions. Components can constitute either software components (e.g., code embodied on a machine-readable medium) or hardware components. A “hardware component” is a tangible unit capable of performing certain operations and can be configured or arranged in a certain physical manner. In various examples, one or more computer systems (e.g., a standalone computer system, a client computer system, or a server computer system) or one or more hardware components of a computer system (e.g., a processor or a group of processors) can be configured by software (e.g., an application or application portion) as a hardware component that operates to perform certain operations as described herein. A hardware component can also be implemented mechanically, electronically, or any suitable combination thereof. For example, a hardware component can include dedicated circuitry or logic that is permanently configured to perform certain operations. A hardware component can be a special-purpose processor, such as a field-programmable gate array (FPGA) or an application-specific integrated circuit (ASIC). A hardware component can also include programmable logic or circuitry that is temporarily configured by software to perform certain operations. For example, a hardware component can include software executed by a general-purpose processor or other programmable processors. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software), can be driven by cost and time considerations. Accordingly, the phrase “hardware component”(or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering examples in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor can be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components can be regarded as being communicatively coupled. Where multiple hardware components exist contemporaneously, communications can be achieved through signal transmission (e.g., over appropriate circuits and buses) between or among two or more of the hardware components. In examples in which multiple hardware components are configured or instantiated at different times, communications between such hardware components can be achieved, for example, through the storage and retrieval of information in memory structures to which the multiple hardware components have access. For example, one hardware component can perform an operation and store the output of that operation in a memory device to which it is communicatively coupled. A further hardware component can then, at a later time, access the memory device to retrieve and process the stored output. Hardware components can also initiate communications with input or output devices, and can operate on a resource (e.g., a collection of information). The various operations of example methods described herein can be performed, at least partially, by one or more processors that are temporarily configured (e.g., by software) or permanently configured to perform the relevant operations. Whether temporarily or permanently configured, such processors can constitute processor-implemented components that operate to perform one or more operations or functions described herein. As used herein, “processor-implemented component” can refer to a hardware component implemented using one or more processors. Similarly, the methods described herein can be at least partially processor-implemented, with a particular processor or processors being an example of hardware. For example, at least some of the operations of a method can be performed by one or more processors or processor-implemented components. Moreover, the one or more processors can also operate to support performance of the relevant operations in a “cloud computing” environment or as a “software as a service” (SaaS). For example, at least some of the operations can be performed by a group of computers (as examples of machines including processors), with these operations being accessible via a network (e.g., the Internet) and via one or more appropriate interfaces (e.g., an API). The performance of certain of the operations can be distributed among the processors, not only residing within a single machine, but deployed across a number of machines. In some examples, the processors or processor-implemented components can be located in a single geographic location (e.g., within a home environment, an office environment, or a server farm). In other examples, the processors or processor-implemented components can be distributed across a number of geographic locations.

“Computer-readable medium” can include, for example, both machine-storage media and signal media. Thus, the terms include both storage devices/media and carrier waves/modulated data signals. The terms “machine-readable medium,” “computer-readable medium” and “device-readable medium” mean the same thing and can be used interchangeably in this disclosure.

“Machine-storage medium” can include, for example, a single or multiple storage devices and media (e.g., a centralized or distributed database, and associated caches and servers) that store executable instructions, routines, and data. The term shall accordingly be taken to include, but not be limited to, solid-state memories, and optical and magnetic media, including memory internal or external to processors. Specific examples of machine-storage media, computer-storage media, and device-storage media include non-volatile memory, including by way of example semiconductor memory devices, e.g., erasable programmable read-only memory (EPROM), electrically erasable programmable read-only memory (EEPROM), Field-Programmable Gate Arrays (FPGA), flash memory devices, Solid State Drives (SSD), and Non-Volatile Memory Express (NVMe) devices; magnetic disks such as internal hard disks and removable disks; magneto-optical disks; and CD-ROM, DVD-ROM, Blu-ray Discs, and Ultra HD Blu-ray discs. In addition, machine-storage medium can also refer to cloud storage services, Network Attached Storage (NAS), Storage Area Networks (SAN), and object storage devices. The terms “machine-storage medium,” “device-storage medium,” “computer-storage medium” mean the same thing and can be used interchangeably in this disclosure. The terms “machine-storage media,” “computer-storage media,” and “device-storage media” specifically exclude carrier waves, modulated data signals, and other such media, at least some of which are covered under the term “signal medium.”

“Network” can include, for example, one or more portions of a network that can be an ad hoc network, an intranet, an extranet, a Virtual Private Network (VPN), a Local Area Network (LAN), a Wireless LAN (WLAN), a Wide Area Network (WAN), a Wireless WAN (WWAN), a Metropolitan Area Network (MAN), the Internet, a portion of the Internet, a portion of the Public Switched Telephone Network (PSTN), a Voice over IP (VoIP) network, a cellular telephone network, a 5G™ network, a wireless network, a Wi-Fi® network, a Wi-Fi 6® network, a Li-Fi network, a Zigbee® network, a Bluetooth® network, another type of network, or a combination of two or more such networks. For example, a network or a portion of a network can include a wireless or cellular network, and the coupling can be a Code Division Multiple Access (CDMA) connection, a Global System for Mobile communications (GSM) connection, or other types of cellular or wireless coupling. In this example, the coupling can implement any of a variety of types of data transfer technology, such as third Generation Partnership Project (3GPP) including 4G, fifth-generation wireless (5G) networks, Universal Mobile Telecommunications System (UMTS), High Speed Packet Access (HSPA), Long Term Evolution (LTE) standard, others defined by various standard-setting organizations, other long-range protocols, or other data transfer technology.

“Non-transitory computer-readable medium” can include, for example, a tangible medium that is capable of storing, encoding, or carrying the instructions for execution by a machine.

“Processor” can include, for example, data processors such as a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application Specific Integrated Circuit (ASIC), a Radio-Frequency Integrated Circuit (RFIC), a Quantum Processing Unit (QPU), a Tensor Processing Unit (TPU), a Neural Processing Unit (NPU), a Field Programmable Gate Array (FPGA), another processor, or any suitable combination thereof. The term “processor” can include multi-core processors that can comprise two or more independent processors (sometimes referred to as “cores”) that can execute instructions contemporaneously. These cores can be homogeneous (e.g., all cores are identical, as in multicore CPUs) or heterogeneous (e.g., cores are not identical, as in many modern GPUs and some CPUs). In addition, the term “processor” can also encompass systems with a distributed architecture, where multiple processors are interconnected to perform tasks in a coordinated manner. This includes cluster computing, grid computing, and cloud computing infrastructures. Furthermore, the processor can be embedded in a device to control specific functions of that device, such as in an embedded system, or it can be part of a larger system, such as a server in a data center. The processor can also be virtualized in a software-defined infrastructure, where the processor's functions are emulated in software.

“Signal medium” can include, for example, an intangible medium that is capable of storing, encoding, or carrying the instructions for execution by a machine and includes digital or analog communications signals or other intangible media to facilitate communication of software or data. The term “signal medium” shall be taken to include any form of a modulated data signal, carrier wave, and so forth. The term “modulated data signal” means a signal that has one or more of its characteristics set or changed in such a matter as to encode information in the signal. The terms “transmission medium” and “signal medium” mean the same thing and can be used interchangeably in this disclosure.

“User device” can include, for example, a device accessed, controlled or owned by a user and with which the user interacts perform an action, engagement or interaction on the user device, including an interaction with other users or computer systems.

1. A machine-implemented method, comprising:
capturing, using a pose tracking component of an extended Reality (XR) system, pose data of the XR system relative to a real-world environment;
capturing, using one or more cameras of the XR system, video data of the real-world environment;
identifying one or more reference features in the real-world environment using the video data and the pose data, the one or more reference features comprising physical features of the real-world environment detected in the video data;
causing display of one or more virtual objects aligned with the one or more reference features using one or more display parameters of the XR system;
causing display of a user interface to a user of the XR system, the user interface for adjusting the one or more display parameters, the one or more display parameters comprising an interpupillary distance (IPD) adjustment parameter;
receiving, from the user using the user interface, one or more adjustments to the one or more display parameters, the XR system continuously updating a rendering of the one or more virtual objects using the one or more adjustments in real-time as the user makes the one or more adjustments;
updating the one or more display parameters using the one or more adjustments;
capturing, using the pose tracking component, an updated pose of the XR system relative to the real-world environment; and
causing re-display of the one or more virtual objects using the updated one or more display parameters and the updated pose.

2. The machine-implemented method of claim 1, wherein the one or more display parameters comprise an Inter-Pupillary Distance (IPD) adjustment display parameter.

3. The machine-implemented method of claim 1, wherein the one or more display parameters comprise at least one of a vertical offset adjustment display parameter, a horizontal offset adjustment display parameter, a left-right asymmetry adjustment display parameter, or a prescription insert adjustment display parameter.

4. The machine-implemented method of claim 1, wherein identifying the one or more reference features comprises receiving from the user a designation of reference features in the real-world environment.

5. The machine-implemented method of claim 4, further comprising:
prompting the user to trace an outline of a physical object in the real-world environment to determine the designation of reference features.

6. The machine-implemented method of claim 1, wherein causing display of the user interface comprises instructing the user to move the XR system and observe an alignment of the one or more virtual objects with the one or more reference features from multiple viewpoints.

7. The machine-implemented method of claim 1, wherein the XR system is a head-wearable apparatus.

8. A machine comprising:
at least one processor; and
at least one memory storing instructions that, when executed by the at least one processor, cause the machine to perform operations comprising:
capturing, using a pose tracking component of an extended Reality (XR) system, pose data of the XR system relative to a real-world environment;
capturing, using one or more cameras of the XR system, video data of the real-world environment;
identifying one or more reference features in the real-world environment using the video data and the pose data, the one or more reference features comprising physical features of the real-world environment detected in the video data;
causing display of one or more virtual objects aligned with the one or more reference features using one or more display parameters of the XR system;
causing display of a user interface to a user of the XR system, the user interface for adjusting the one or more display parameters, the one or more display parameters comprising an interpupillary distance (IPD) adjustment parameter;
receiving, from the user using the user interface, one or more adjustments to the one or more display parameters the XR system continuously updating a rendering of the one or more virtual objects using the one or more adjustments in real-time as the user makes the one or more adjustments;
updating the one or more display parameters using the one or more adjustments;
capturing, using the pose tracking component, an updated pose of the XR system; and
causing re-display of the one or more virtual objects using the updated one or more display parameters and the updated pose.

9. The machine of claim 8, wherein the one or more display parameters comprise an Inter-Pupillary Distance (IPD) adjustment display parameter.

10. The machine of claim 8, wherein the one or more display parameters comprise at least one of a vertical offset adjustment display parameter, a horizontal offset adjustment display parameter, a left-right asymmetry adjustment display parameter, or a prescription insert adjustment display parameter.

11. The machine of claim 8, wherein identifying the one or more reference features comprises receiving from the user a designation of reference features in the real-world environment.

12. The machine of claim 11, wherein the operations further comprise:
prompting the user to trace an outline of a physical object in the real-world environment to determine the designation of reference features.

13. The machine of claim 8, wherein causing display of the user interface comprises instructing the user to move the XR system and observe an alignment of the one or more virtual objects with the one or more reference features from multiple viewpoints.

14. The machine of claim 8, wherein the XR system is a head-wearable apparatus.

15. A machine-storage medium, the machine-storage medium including instructions that, when executed by a machine, cause the machine to perform operations comprising:
capturing, using a pose tracking component of an extended Reality (XR) system, pose data of the XR system relative to a real-world environment;
capturing, using one or more cameras of the XR system, video data of the real-world environment;
identifying one or more reference features in the real-world environment using the video data and the pose data, the one or more reference features comprising physical features of the real-world environment detected in the video data;
causing display of one or more virtual objects aligned with the one or more reference features using one or more display parameters of the XR system,
causing display of a user interface to a user of the XR system, the user interface for adjusting the one or more display parameters, the one or more display parameters comprising an interpupillary distance (IPD) adjustment parameter;
receiving, from the user using the user interface, one or more adjustments to the one or more display parameters, the XR system continuously updating a rendering of the one or more virtual objects using the one or more adjustments in real-time as the user makes the one or more adjustments;
updating the one or more display parameters using the one or more adjustments;
capturing, using the pose tracking component, an updated pose of the XR system, and
causing re-display of the one or more virtual objects using the updated one or more display parameters and the updated pose.

16. The machine-storage medium of claim 15, wherein the one or more display parameters comprise an Inter-Pupillary Distance (IPD) adjustment display parameter.

17. The machine-storage medium of claim 15, wherein the one or more display parameters comprise at least one of a vertical offset adjustment display parameter, a horizontal offset adjustment display parameter, a left-right asymmetry adjustment display parameter, or a prescription insert adjustment display parameter.

18. The machine-storage medium of claim 15, wherein identifying the one or more reference features comprises receiving from the user a designation of reference features in the real-world environment.

19. The machine-storage medium of claim 18, wherein the operations further comprise:
prompting the user to trace an outline of a physical object in the real-world environment to determine the designation of reference features.

20. The machine-storage medium of claim 15, wherein causing display of the user interface comprises instructing the user to move the XR system and observe an alignment of the one or more virtual objects with the one or more reference features from multiple viewpoints.
